(19) United States
(12) Patent Application Publication
(10) Pub. No.: US 2024/0073980 A1
(43) Pub. Date: Feb. 29, 2024

(54) CONDITIONAL SECONDARY NODE OPERATIONS

(71) Applicant: GOOGLE LLC, Mountain View, CA (US)

(72) Inventors: Chih-Hsiang Wu, Taoyuan City (TW); Jing Hsieh, Taipei City (TW)

(21) Appl. No.: 17/766,529

(22) PCT Filed: Oct. 2, 2020
(86) PCT No.: PCT/US20/54098

§ 371 Date: Apr. 4, 2022

Related U.S. Application Data
(60) Provisional application No. 62/973,491, filed on Oct. 3, 2019.

(51) Int. Cl. H04W 76/15; H04L 5/00; H04W 76/20

(52) U.S. Cl. CPC H04W 76/15; H04L 5/001; H04L 5/0032; H04L 5/0098; H04W 76/20

(57) ABSTRACT

A first base station providing to the UE configuration data related to a second base station and at least one condition for connecting to the second base station in order to operate in dual connectivity with the first base station and the second base station (1802). The base station receiving from the UE a first indication that the UE has conditionally applied the configuration data (1804). Subsequently to receiving the first indication, the base station receives a second indication that the at least one condition is satisfied (1806).

### FIELD OF THE DISCLOSURE

This disclosure relates generally to wireless communications and, more particularly, to conditional operations related to secondary nodes.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP TS 36.323) and New Radio (NR) (see TS 38.323) provides sequencing of protocol data units (PDUs) in the uplink direction (from a user equipment (UE) to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages and use DRBs to transport data on a user plane.

UEs can use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). So-called SRB1 resources carry RRC messages, which in some cases include non-access stratum (NAS) messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of either the MN or the SN, or both can be referred to as split DRBs.

3GPP specification TS 37.340 (v15.6.0) describes procedures for adding or changing an SN in dual connectivity (DC) scenarios. These procedures involve messaging (e.g., RRC signaling and preparation) between RAN nodes (e.g., base stations or components of a distributed base station) that generally causes latency, which in turn increases the probability of failure of SN addition or SN change procedures. These procedures do not involve conditions associated with the UE, and can be referred to as “immediate” SN addition and change procedures.

### SUMMARY

A base station and a UE of this disclosure implement procedures in which the UE connects to a secondary node (SN) in dual connectivity (DC) subject to a certain condition, such as the signal quality the UE measures in a cell. According to the “conditional” SN addition procedure, the UE receives a configuration for a candidate SN (C-SN) along with one or more conditions from a base station, and initiates a connection to the C-SN (e.g., by performing a random access procedure) only if and when the condition(s) is (are) satisfied. When the UE connects to the C-SN, the base station that provided the configuration data and the condition operates as a master node (MN) and the C-SN operates as an SN, to allow the UE to communicate data in DC with the MN and SN.

To reduce latency, the UE and/or the C-SN notifies the MN that the UE has connected to the C-SN. For example, the UE or the C-SN can send a message to the MN after the UE has successfully completed the random access procedure.

Further, the MN in some cases determines that the UE should no longer consider the candidacy of a C-SN and notifies the UE and/or the C-SN, prior to the UE determining that the condition for adding the C-SN is satisfied. In other cases, the C-SN determines that the UE should no longer consider the candidacy of the C-SN and notifies the MN.

Still further, the MN in some cases determines that the UE should continue consider the candidacy of a C-SN, but also determines that the configuration and/or the conditions should change. Thus, the MN determines that the UE should not connect to the C-SN in accordance with the previous configuration. The MN in these cases provides the new configuration to the UE and/or notifies the C-SN, prior to the UE determining that the condition for adding the C-SN is satisfied. In other cases, the C-SN rather than the MN determines a change in configuration and notifies the MN accordingly.

### BRIEF DESCRIPTION OF THE DRAWINGS

FIG. 1A is a block diagram of an example system in which a radio access network (RAN) and a user device can implement the techniques of this disclosure for managing conditional procedures related to a secondary node (SN);

FIG. 1B is a block diagram of an example base station in which a centralized unit (CU) and a distributed unit (DU) that can operate in the system of FIG. 1A;

FIG. 2 is a block diagram of an example protocol stack according to which the UE of FIG. 1A communicates with base stations;

FIG. 3 is a messaging diagram of an example scenario in which a candidate SN (C-SN) notifies a master node (MN) that a UE, which previously operated in single connectivity (SC) with the MN, has connected to the C-SN;

FIG. 4A is a messaging diagram of an example scenario in which the candidate C-SN notifies the MN that the UE, which previously operated in dual connectivity (DC) with the MN and an SN, has connected to the C-SN;

FIG. 4B is a messaging diagram of an example scenario in which the SN notifies the MN that the UE, which previously operated in DC with the MN and the SN, has connected to a candidate primary secondary cell of the SN;

FIG. 5 is a messaging diagram of an example scenario in which the UE notifies the MN that the UE, which previously operated in SC with the MN, has connected to the C-SN;

FIG. 6A is a messaging diagram of an example scenario in which the UE notifies the MN that the UE, which previously operated in DC with the MN and an SN, has connected to the C-SN;

FIG. 6B is a messaging diagram of an example scenario in which the UE notifies the MN that the UE, which previously operated in DC with the MN and the SN, has connected to a candidate primary secondary cell of the SN;

FIG. 7A is a messaging diagram of an example scenario in which the UE notifies the MN that the UE, which previously operated in SC with the MN, has connected to the C-SN, by reporting completion of the radio connection reconfiguration after performing a random access procedure with the C-SN;

FIG. 7B is a messaging diagram of an example scenario in which the UE, which initially operates in SC with the MN, performs a random access procedure with the SN and begins to operate in DC with the MN and the SN prior to checking conditions for the C-SN;

FIG. 8A is a messaging diagram of an example scenario in which the UE notifies the MN that the UE, which previously operated in DC with the MN and the SN, has connected to the C-SN, by reporting completion of the radio connection reconfiguration after performing a random access procedure with the C-SN;

FIG. 8B is a messaging diagram of an example scenario in which the UE notifies the MN that the UE, which previously operated in DC with the MN and SN, has connected to the C-PSCell of the SN, by reporting completion of the radio connection reconfiguration after performing a random access procedure with the SN;

FIG. 9A is a messaging diagram of an example scenario in which the MN determines that it should release the C-SN, and accordingly releases the C-SN, prior to the UE detecting that the condition for connecting to the C-SN is satisfied;

FIG. 9B is a messaging diagram of an example scenario in which the C-SN determines that it should be released, and notifies the MN accordingly, prior to the UE detecting that the condition for connecting to the C-SN is satisfied;

FIG. 10A is a messaging diagram of an example scenario in which the MN determines that it should release the C-SN, and accordingly releases the C-SN, prior to the UE detecting that the condition for connecting to the C-SN is satisfied, when the UE operates in DC with the MN and the SN;

FIG. 10B is a messaging diagram of an example scenario in which the C-SN determines that it should be released, and notifies the MN accordingly, prior to the UE detecting that the condition for connecting to the C-SN is satisfied, when the UE operates in DC with the MN and the SN;

FIG. 11A is a messaging diagram of an example scenario in which the MN determines that the configuration for the C-SN should be updated, prior to the UE detecting that the condition for connecting to the C-SN is satisfied;

FIG. 11B is a messaging diagram of an example scenario in which the C-SN determines that the configuration for the C-SN should be updated, and notifies the MN accordingly, prior to the UE detecting that the condition for connecting to the C-SN is satisfied;

FIG. 12A is a messaging diagram of an example scenario in which the MN determines that the configuration for the C-SN should be updated, prior to the UE detecting that the condition for connecting to the C-SN is satisfied, when the UE operates in DC with the MN and the SN;

FIG. 12B is a messaging diagram of an example scenario in which the C-SN determines that the configuration for the C-SN should be updated, and notifies the MN accordingly, prior to the UE detecting that the condition for connecting to the C-SN is satisfied, when the UE operates in DC with the MN and the SN;

FIG. 13A is a flow diagram of an example method in an MN for configuring the UE and the C-SN for addition of the C-SN to a radio connection between the UE and the MN, subject to at least one condition;

FIG. 13B is a flow diagram of an example method in an MN for releasing the C-SN and causing the UE to release the configuration data related to the C-SN;

FIG. 14 is a flow diagram of an example method in a UE for connecting to the C-SN via a C-PSCell, after detecting that a condition for connecting to the C-PSCell is satisfied;

FIG. 15 is a flow diagram of an example method in an SN for notifying an MN that a UE has connected to the SN upon completing a conditional SN addition procedure;

FIG. 16 is a flow diagram of an example method in an MN for determining whether a UE should go through an immediate (unconditional) SN addition procedure or a conditional SN addition procedure, in view of the measurements received from the UE;

FIG. 17 is a flow diagram of an example method in an MN for determining whether a UE should go through an immediate SN release procedure or a conditional SN release procedure, in view of the measurements received from the UE;

FIG. 18 is a flow diagram of an example method for determining whether a conditional SN addition procedure has been completed, which can be implemented in a base station of FIG. 1A;

FIG. 19 is a flow diagram of an example method for notifying an MN of connecting to an SN subject to a condition, which can be implemented in the UE of FIG. 1A;

FIG. 20 is a flow diagram of an example method for modifying a configuration for, or releasing, a C-SN, which can be implemented in a base station of FIG. 1A; and

FIG. 21 is a flow diagram of an example method for modifying or releasing configuration data for a C-SN, which can be implemented in the UE of FIG. 1A.

### DETAILED DESCRIPTION OF THE DRAWINGS

Generally speaking, the communication devices of this disclosure implement procedures related to conditional addition of a secondary node (SN). As discussed below, the UE and/or a candidate SN (C-SN) can notify the master node (MN) that the UE has determined that one or more conditions for connecting to the C-SN are satisfied, that the UE has connected to the C-SN, and the C-SN accordingly has started operating as an SN. The MN then can perform one or more procedures for completing the SN addition procedure. In this manner, the communication devices reduce latency and the rate at which the SN addition procedure fails. The UE, the MN, and the C-SN of this disclosure also can support procedures for releasing a C-SN as a candidate SN or modifying the configuration data and/or the conditions associated with the C-SN, as discussed below.

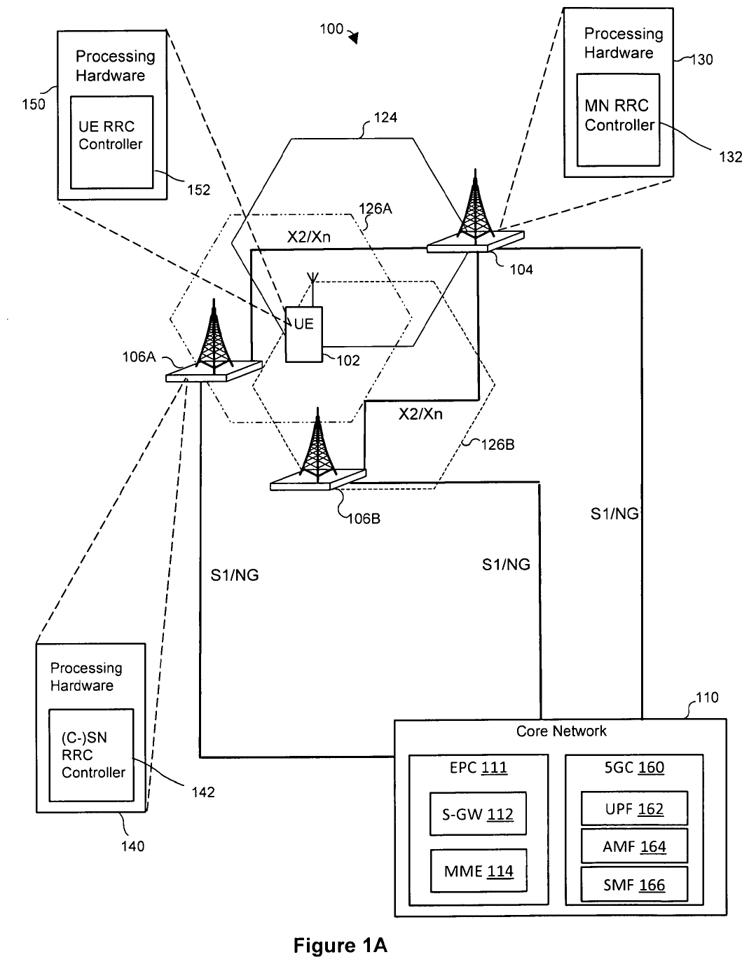

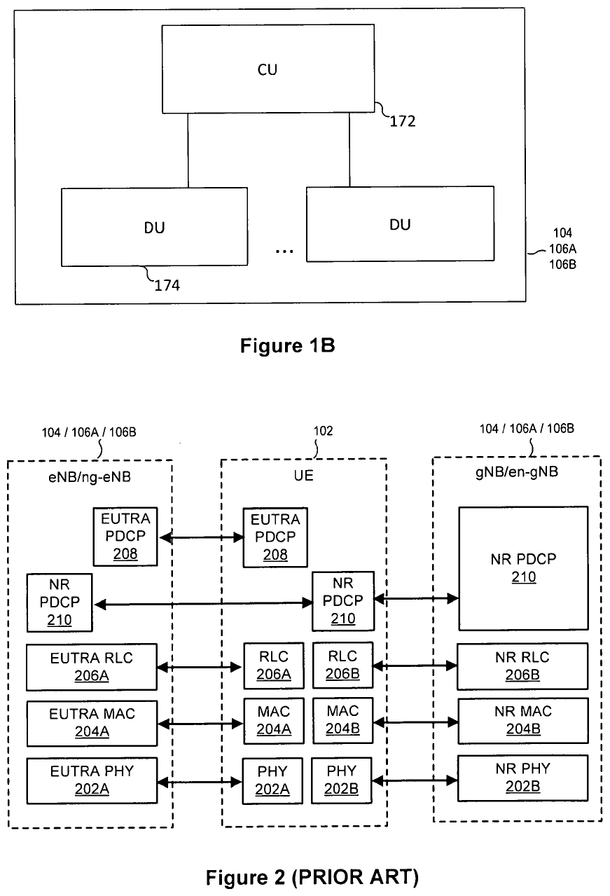

FIG. 1A depicts an example wireless communication system 100 in which communication devices can implement these techniques. The wireless communication system 100 includes a UE 102, a base station 104, a base station 106A, a base station 106B and a core network (CN) 110. The UE 102 initially connects to the base station 104.

In some scenarios, the base station 104 can perform immediate SN addition to configure the UE 102 to operate in dual connectivity (DC) with the base station 104 and the base station 106A. The base stations 104 and 106A operate as an MN and an SN for the UE 102, respectively. Later on, the MN 104 can perform an immediate SN change to change the SN of the UE 102 from the base station 106A (source SN, or “S-SN”) to the base station 106B (target SN, or “T-SN”) while the UE 102 is in DC with the MN 104 and the S-SN 106A.

In other scenarios, the base station 104 can perform a conditional SN Addition procedure to first configure the base station 106A as a candidate SN (C-SN) for the UE 102. At this time, the UE 102 can be in single connectivity (SC) with the base station 104 or in DC with the base station 104 and another base station 106B. In contrast to the immediate SN Addition case discussed above, the UE 102 does not immediate attempt to connect to the C-SN 106A. In this scenario, the base station 104 again operates as an MN, but the base station 106A initially operates as a C-SN rather than SN.

More particularly, when the UE 102 receives a configuration for the C-SN 106A, the UE 102 does not connect to the C-SN 106A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the candidate SN 106A, so that the C-SN 106A begins to operate as the SN 106A for the UE 102. Thus, while the base station 106A operates as a C-SN rather than an SN, the base station 106A is not yet connected to the UE 102, and accordingly is not yet servicing the UE 102.

In some scenarios, the condition associated with conditional SN addition can be signal strength/quality, which the UE 102 detects on a candidate primary secondary cell (PSCell) of the C-SN 106A, exceeding a certain threshold or otherwise corresponding to an acceptable measurement. For example, when the one or more measurement results the UE 102 obtains on the candidate PSCell (C-PSCell) are above a threshold configured by the MN 104 or above a pre-determined or pre-configured threshold, the UE 102 determines that the condition is satisfied. When the UE 102 determines that the signal strength/quality on C-PSCell of the C-SN 106A is sufficiently good (again, measured relative to one or more quantitative thresholds or other quantitative metrics), the UE 102 can perform a random access procedure with the C-SN 106A to connect to the candidate SN 106A. Once the UE 102 successfully completes the random access procedure, the base station 106A begins to operate as an SN, and the C-PSCell becomes a PSCell for the UE 102. The SN 106A then can start communicating data with the UE 102.

In various configurations of the wireless communication system 100, the base station 104 can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104 and the base station 106A or 106B (106A/B) via the same RAT such as EUTRA or NR, or different RATs. When the base station 104 is an MeNB and the base station 106A is a SgNB, the UE 102 can be in EUTRA-NR DC (EN-DC) with the MeNB and the SgNB. In this scenario, the MeNB 104 may or may not configure the base station 106B as a C-SgNB to the UE 102. When the base station 104 is an MeNB and the base station 106A is a C-SgNB for the UE 102, the UE 102 can be in SC with the MeNB. In this scenario, the MeNB 104 may or may not configure the base station 106B as another C-SgNB to the UE 102.

In some cases, an MeNB, an SeNB or a C-SgNB is implemented as an ng-eNB rather than an eNB. When the base station 104 is an Master ng-eNB (Mng-eNB) and the base station 106A is a SgNB, the UE 102 can be in next generation (NG) EUTRA-NR DC (NGEN-DC) with the Mng-eNB and the SgNB. In this scenario, the MeNB 104 may or may not configure the base station 106B as a C-SgNB to the UE 102. When the base station 104 is an Mng-NB and the base station 106A is a C-SgNB for the UE 102, the UE 102 can be in SC with the Mng-NB. In this scenario, the Mng-eNB 104 may or may not configure the base station 106B as another C-SgNB to the UE 102.

When the base station 104 is an MgNB and the base station 106A/B is an SgNB, the UE 102 may be in NR-NR DC (NR-DC) with the MgNB and the SgNB. In this scenario, the MeNB 104 may or may not configure the base station 106B as a C-SgNB to the UE 102. When the base station 104 is an MgNB and the base station 106A is a C-SgNB for the UE 102, the UE 102 may be in SC with the MgNB. In this scenario, the MgNB 104 may or may not configure the base station 106B as another C-SgNB to the UE 102.

When the base station 104 is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104 may or may not configure the base station 106B as a C-Sng-eNB to the UE 102. When the base station 104 is an MgNB and the base station 106A is a candidate Sng-eNB (C-Sng-eNB) for the UE 102, the UE 102 may be in SC with the MgNB. In this scenario, the MgNB 104 may or may not configure the base station 106B as another C-Sng-eNB to the UE 102.

The base stations 104, 106A, and 106B can connect to the same core network (CN) 110 which can be an evolved packet core (EPC) 111 or a fifth-generation core (5GC) 160. The base station 104 can be implemented as an eNB supporting an S1 interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an S1 interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104, 106A, and 106B can support an X2 or Xn interface.

Among other components, the EPC 111 can include a Serving Gateway (S-GW) 112 and a Mobility Management Entity (MME) 114. The S-GW 112 in general is configured to transfer user-plane packets related to audio calls, video calls, Internet traffic, etc., and the MME 114 is configured to manage authentication, registration, paging, and other related functions. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, the base station 106A supports a cell 126A, and the base station 106B supports a cell 126B. The cells 124 and 126A can partially overlap, as can the cells 124 and 126B, so that the UE 102 can communicate in DC with the base station 104 (operating as an MN) and the base station 106A (operating as an SN) and, upon completing an SN change, with the base station 104 (operating as MN) and the SN 106B. More particularly, when the UE 102 is in DC with the base station 104 and the base station 106A, the base station 104 operates as an MeNB, a Mng-eNB or a MgNB, and the base station 106A operates as an SgNB or a Sng-eNB. when the UE 102 is in SC with the base station 104, the base station 104 operates as an MeNB, a Mng-eNB or a MgNB, and the base station 106A operates as a C-SgNB or a C-Sng-eNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes an MN RRC controller 132 configured to manage or control one or more RRC configurations or RRC procedures when the base station 104 operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes an (C-)SN RRC controller 142 configured to manage or control one or more RRC configurations and/or RRC procedures when the base station 106A operates as an SN or a candidate SN (C-SN). The base station 106B can have hardware same as or similar to the base station 106A.

Although FIG. 1A illustrates the RRC controllers 132 and 142 as operating in an MN and a SN, respectively, a base station generally can operate as an MN, an SN or a candidate SN in different scenarios. Thus, the MN 104, the SN 104A, and the SN 106B can implement similar sets of functions and support both MN, SN and conditional SN operations.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE RRC controller 152 configured to manage or control one or more RRC configurations and/or RRC procedures.

In operation, the UE 102 can use a radio bearer (e.g., a DRB or an SRB) that at different times terminates at the MN 104 or the SN 106A. The UE 102 can apply one or more security keys when communicating on the radio bearer, in the uplink (from the UE 102 to a base station) and/or downlink (from a base station to the UE 102) direction.

FIG. 1B depicts an example distributed implementation of a base station such as the base station 104, 106A, or 106B. The base station in this implementation can include a centralized unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller 142 configured to manage or control one or more RRC configurations and/or RRC procedures when the base station 106A operates as an SN or a candidate SN (C-SN). The base station 106B can have hardware same as or similar to the base station 106A. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 106A operates as a MN, an SN or a candidate SN (C-SN). The process hardware may include further a physical layer controller configured to manage or control one or more physical layer operations or procedures.

Next, FIG. 2 illustrates in a simplified manner a radio protocol stack according to which the UE 102 can communicate with an eNB/ng-eNB or a gNB. Each of the base stations 104, 106A, or 106B can be the eNB/ng-eNB or the gNB.

The physical layer (PHY) 202A of EUTRA provides transport channels to the EUTRA Medium Access Control (MAC) sublayer 204A, which in turn provides logical channels to the EUTRA Radio Link Control (RLC) sublayer 206A, and the EUTRA RLC sublayer in turn provides RLC channels to the EUTRA PDCP sublayer 208 and, in some cases, NR PDCP sublayer 210. Similarly, the PHY 202B of NR provides transport channels to the NR MAC sublayer 204B, which in turn provides logical channels to the NR RLC sublayer 206B, and the NR RLC sublayer 206B in turn provides RLC channels to the NR PDCP sublayer 210. The UE 102 in some implementations supports both the EUTRA and the NR stack, to support handover between EUTRA and NR base stations and/or DC over EUTRA and NR interfaces. Further, as illustrated in FIG. 2A, the UE 102 can support layering of NR PDCP 210 over EUTRA RLC 206A.

The EUTRA PDCP sublayer 208 and the NR PDCP sublayer 210 receive packets (e.g., from the Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 provide SRBs to exchange Radio Resource Control (RRC) messages, for example. On a user plane, the EUTRA PDCP sublayer 208 and the NR PDCP sublayer 210 provide DRBs to support data exchange.

When the UE 102 operates in EUTRA/NR DC (EN-DC), with the BS 104A operating as a MeNB and the BS 106A operating as a SgNB, the network can provide the UE 102 with an MN-terminated bearer that uses EUTRA PDCP 208 or MN-terminated bearer that uses NR PDCP 210. The network in various scenarios also can provide the UE 102 with an SN-terminated bearer, which use only NR PDCP 210. The MN-terminated bearer can be an MCG bearer or a split bearer. The SN-terminated bearer can be a SCG bearer or a split bearer. The MN-terminated bearer can be an SRB (e.g., SRB1 or SRB2) or a DRB. The SN-terminated bearer can an SRB (e.g., SRB) or a DRB.

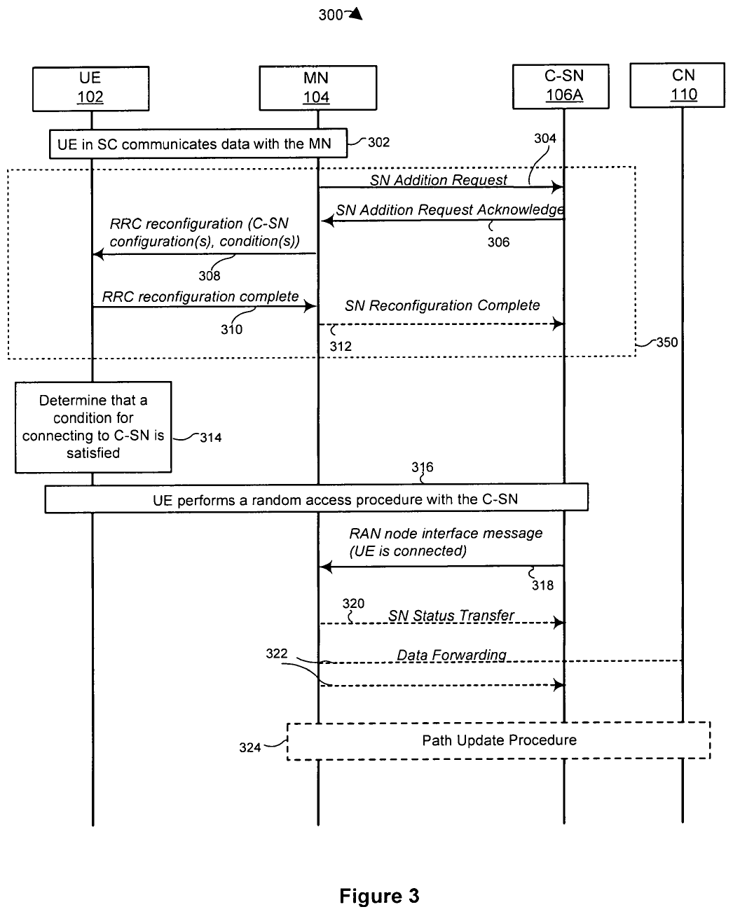

Next, several example scenarios in which the MN 104 initiates a conditional SN Addition procedure are discussed with reference to FIGS. 3-8B.

Referring first to FIG. 3, the base station 104 in a scenario 300 operates as an MN, and the base station 106A operates as a C-SN. Initially, the UE 102 in SC with the MN 104 communicates 302 data (e.g., UL Data PDUs and/or DL Data PDUs) with MN 104. The MN 104 can determine that it should initiate a first conditional SN Addition procedure to configure the base station 106A as a C-SN for the UE 102. The MN 104 can make this determination based on one or more measurement results received from the UE 102, for example, or another suitable event. In response to this determination, the MN 104 sends 304 an SN Addition Request message to the C-SN 106A to initiate a conditional SN Addition procedure. In response to receiving 304 the SN Addition Request message, the C-SN 106A includes at least one configuration of the C-SN in an SN Addition Request Acknowledge message for the UE 102. The SN 106A then sends 306 the SN Addition Request Acknowledge message to the MN 104, in response to the SN Addition Request message. The first C-SN configuration included in this message can include one or more configuration parameters for at least one C-PSCell.

For convenience, the discussion below refers to the configuration in singular, but it will be understood that the C-SN 106A can provide multiple configuration parameters. Further, this configuration in some cases can be referred to as the initial or first C-SN configuration in contrast to subsequent or second C-SN configuration which the UE 102 receives in some scenarios discussed below.

In some implementations, the MN 104 can include in the SN Addition Request message a request that the base station 106A operate as a C-SN for the UE 102. In one implementation, the first C-SN configuration includes parameters for the C-SN or the one or more C-PSCells of the C-SN, which the UE 102 can use to communicate with the C-SN 106A when the UE determines that the condition is satisfied.

In some implementations, the MN 104 can include the C-SN configuration and, in some cases, one or more conditions for connecting to the C-SN 106A associated with the C-SN configuration, in an RRC reconfiguration message. This message can be referred to as the first RRC configuration message, in contrast to a subsequent, second RRC configuration message the MN 104 sends to the UE 102 in some of the scenarios below. The information in the first RRC reconfiguration message can include one or more indicators or parameters such as a field name, a dedicated information element (IE), and/or an indication of the condition(s) associated with the first C-SN configuration.

In some implementations, the first C-SN configuration can include one or more cell group configuration (CellGroupConfig) IEs that configure C-PSCell(s). For example, the first C-SN configuration can include one or more CellGroupConfig IEs configuring respective C-PSCells. In one implementation, the SN 106A may include a RRCReconfiguration message including the one or more CellGroupConfig IEs in the SN Addition Request Acknowledge message. In other implementations, the first C-SN configuration can include one or more CellGroupConfig IEs configuring C-PSCell(s). In one implementation, the first C-SN configuration can include one or more RRCReconfiguration messages, each including a CellGroupConfig 1E. Each of the one or more CellGroupConfig IEs may be associated with a particular C-PSCell of the C-PSCell(s). In further implementations, the first C-SN configuration can be included in a CellGroupConfig 1E included in the SN Addition Request Acknowledge message. The CellGroupConfig 1E can conform to 3GPP TS 38.331.

In other implementations, the first C-SN configuration can be one or more SCG-ConfigPartSCG-r12 IEs configuring C-PSCell(s). For example, the first C-SN configurations can be one or more ConfigPartSCG-r12 IEs, each configuring a particular C-PSCell. In one implementation, the SN 106A may include a RRCConnectionReconfiguration message including the one or more ConfigPartSCG-r12 IEs in the SN Addition Request Acknowledge message. In other implementations, the first C-SN configuration can include ConfigPartSCG-r12 IEs configuring C-PSCell(s). In one implementation, the first C-SN configuration can include multiple RRCConnectionReconfiguration messages, each including a ConfigPartSCG-r12 IE. Each of the one or more ConfigPartSCG-r12 IEs may be associated with a particular C-PSCell within the set of C-PSCell(s). In further implementations, the first C-SN configuration can be included in a ConfigPartSCG-r12 IE included in the SN Addition Request Acknowledge message. The SCG-ConfigPartSCG-r12 IE can conform to 3GPP TS 36.331.

In some implementations, a condition can be an event-based triggering as shown below.

If the UE 102 is configured with an event A3 (C-PSCell cell becomes offset better than a primary secondary Cell (PSCell)), the UE 102 performs the following:
consider the entering condition for this event to be satisfied when condition A3-1, as specified below, is fulfilled;
consider the leaving condition for this event to be satisfied when condition A3-2, as specified below, is fulfilled;
use the PSCell for Mp, Ofp and Ocp.

Mn+Ofn+Ocn−Hys>Mp+Ofp+Ocp+Off Inequality A3-1 (Entering condition)

Mn+Ofn+Ocn+Hys<Mp+Ofp+Ocp+Off Inequality A3-2 (Leaving condition)

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. celllndividualOffset as defined within measObjectNR corresponding to the frequency of the neighbour cell), and set to zero if not configured for the neighbour cell.
Mp is the measurement result of the PSCell, not taking into account any offsets.
Ofp is the measurement object specific offset of the PSCell (i.e. offsetMO as defined within measObjectNR corresponding to the PSCell).
Ocp is the cell specific offset of the PSCell (i.e. celllndividualOffset as defined within measObjectNR corresponding to the PSCell), and is set to zero if not configured for the PSCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.
   If the entering condition is fulfilled for a C-PSCell, the UE 102 in DC may disconnect from the PSCell of a SN of the UE 102 and connect to the C-PSCell. In one implementation, the UE 102 immediately disconnects from the PSCell and connects to the C-PSCell (e.g., performing a random access procedure via the C-PSCell). In another implementation, the UE 102 disconnects from the PSCell and connects to the C-PSCell if the entering condition is continuously fulfilled for a time period (e.g., TimeToTrigger). If the leaving condition is fulfilled for the C-PSCell during the time period, the UE 102 does not connect to the C-PSCell.

Event A4 (C-PSCell becomes better than a threshold)

The UE shall:
consider the entering condition for this event to be satisfied when condition A4-1, as specified below, is fulfilled;
consider the leaving condition for this event to be satisfied when condition A4-2, as specified below, is fulfilled.

Mn+Ofn+Ocn−Hys>Thresh Inequality A4-1 (Entering condition)

Mn+Ofn+Ocn+Hys<Thresh Inequality A4-2 (Leaving condition)

The variables in the formula are defined as follows:
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the measurement object specific offset of the neighbour cell (i.e. celllndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.
   If the entering condition is fulfilled for a C-PSCell, the UE 102 in SC may connect to the C-PSCell. In one implementation, the UE 102 immediately connects to the C-PSCell (e.g., performing a random access procedure via the C-PSCell). In another implementation, the UE 102 connects to the C-PSCell if the entering condition is continuously fulfilled for a time period (e.g., TimeToTrigger). If the leaving condition is fulfilled for the C-PSCell during the time period, the UE 102 does not connect to the C-PSCell.

Event A5 (PSCell becomes worse than threshold1 and C-PSCell becomes better than threshold2)

The UE shall:
consider the entering condition for this event to be satisfied when both condition A5-1 and condition A5-2, as specified below, are fulfilled;
consider the leaving condition for this event to be satisfied when condition A5-3 or condition A5-4, i.e. at least one of the two, as specified below, is fulfilled;
use the PSCell for Mp.

Mp+Hys<Thresh1 Inequality A5-1 (Entering condition 1)

Mn+Ofn+Ocn−Hys>Thresh2 Inequality A5-2 (Entering condition 2)

Mp−Hys>Thresh1 Inequality A5-3 (Leaving condition 1)

Mn+Ofn+Ocn+Hys<Thresh2 Inequality A5-4 (Leaving condition 2)

The variables in the formula are defined as follows:
Mp is the measurement result of the NR PSCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. celllndividualOffset as defined within measObjectNR corresponding to the neighbour cell), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.
   If the entering condition is fulfilled for a C-PSCell, the UE 102 in DC may disconnect from the PSCell of a SN of the UE 102 and connect to the C-PSCell. In one implementation, the UE 102 immediately disconnects from the PSCell and connects to the C-PSCell (e.g., performing a random access procedure via the C-PSCell). In another implementation, the UE 102 disconnects from the PSCell and connects to the C-PSCell if the entering condition is continuously fulfilled for a time period (e.g., TimeToTrigger). If the leaving condition is fulfilled for the C-PSCell during the time period, the UE 102 does not connect to the C-PSCell.

An EventTriggerConfig 1E is an example to configure a condition.

| | |
|---|---|
| EventTriggerConfig::= | SEQUENCE { |
| eventId | CHOICE { |
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useWhiteCellList | BOOLEAN |
| }, | |
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useWhiteCellList | BOOLEAN |
| }, | |
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useWhiteCellList | BOOLEAN |
| }, | |
| ... | |
| }, | |

With continued reference to FIG. 3, in response to receiving 306 the SN Addition Request Acknowledge message, the MN 104 includes the first C-SN configuration (which again can include more than one sets of configuration parameters) and at least one condition in the first RRC reconfiguration message and transmits 308 the first RRC reconfiguration message to the UE 102. The UE 102 transmits 310 a first RRC reconfiguration complete message to the MN 104 in response to the first RRC reconfiguration message. The MN 104 in some implementations can send 312 a SN Reconfiguration Complete message to the C-SN 106A in response to the RRC reconfiguration complete message. The MN 104 in other implementations does not send 312 a SN Reconfiguration Complete message to the C-SN 106A in response to the RRC reconfiguration complete message, and thus FIG. 3 depicts this message as being optional.

The events 304, 306, 308, 310 and 312 collectively can be considered to define a conditional configuration procedure 350.

The UE 102 applies the received one or more conditions (discussed below in singular for convenience) to determine whether to connect to the C-SN 106A. If the UE 102 determines that the condition is satisfied, the UE 102 connects to the C-SN 106A. If the UE 102 does not determine that the condition is satisfied, the UE 102 does not connect to the C-SN 106A. In some implementations, a condition may be specific for one, some, or all of the C-PSCell(s). If the UE 102 detects that the condition for connecting to a first C-PSCell is satisfied, the UE 102 performs a random access procedure via the first C-PSCell with the C-SN 106A to connect to the C-SN 106. If the UE 102 detects that none of the conditions for connecting to the first C-PSCell is satisfied, the UE 102 does not perform a random access procedure via the first C-PSCell with the C-SN 106A.

Depending on the implementation, the UE 102 can connect to the C-SN 106 if one but not necessarily all of the multiple conditions is satisfied, or the UE 102 can connect to the C-SN 106 only if every condition is satisfied.

When the UE 102 determines 314 that one or more conditions for connecting to a first C-PSCell is satisfied, the UE 102 initiates 314 a random access procedure via the first C-PSCell with the C-SN 106A in response to the detection. The UE 102 performs 316 a random access procedure with the C-SN 106A, and the C-SN 106A can identifies the UE 102 during this procedure. In response to identifying the UE 102, the C-SN 106A sends 318 to the MN 104 a RAN node interface message indicating that the UE 102 is connected. As discussed above, the C-SN 106A may consist of a CU and a DU as shown in FIG. 2. In this case, the DU can perform the random access procedure with the UE 102 and identify the UE 102 in the random access procedure, while the CU can exchange messages with the MN 104 as illustrated in FIG. 3.

In some implementations, the UE 102 includes a UE identity of the UE 102 in a MAC PDU which the UE 102 sends during the random access procedure. Thus, the C-SN 106A in this implementation identifies the UE 102 using the UE identity.

In some implementations, the C-SN 106A generates the UE identity and includes the UE identity in the first C-SN configuration. In other implementations, a CU of the C-SN 106A generates the UE identity and includes the UE identity in the first C-SN configuration. In yet other implementations, a DU of the C-SN 106A generates the UE identity, includes the UE identity in the first C-SN configuration and sends the first C-SN configuration to a CU of the C-SN 106A. In further implementations, a DU of the C-SN 106A generates the UE identity and sends the UE identity to a CU of the C-SN 106A, and the CU of the C-SN 106A includes the UE identity in the first C-SN configuration. In additional implementations, the UE 102 and the C-SN 106A receives the UE identity from the MN 104 or CN 110. In one implementation, the UE identity can be a RAN identity or a CN identity. For example, the UE identity can be a cell-radio network temporary identifier (C-RNTI), or a Temporary Mobile Subscriber Identity (S-TMSI) or 5G S-TMSI.

The C-SN 106A can identify the UE based on the dedicated random access preamble received from the UE 102 in the random access procedure. In some implementations, the C-SN 106A configures the dedicated random access preamble in a random access configuration and includes the random access configuration in the first C-SN configuration. In other implementations, a CU of the C-SN 106A configures a dedicated random access preamble in a random access configuration and includes the random access configuration in the first C-SN configuration. In yet other implementations, a DU of the C-SN 106A configures a dedicated random access preamble in a random access configuration, includes the random access configuration in the first C-SN configuration and sends the first C-SN configuration to a CU of the C-SN 106A. In further implementations, a DU of the C-SN 106A configures a dedicated random access preamble in a random access configuration and sends the random access configuration to a CU of the C-SN 106A, and the CU of the C-SN 106A includes the random access configuration in the first C-SN configuration.

After the C-SN 106A identifies the UE 102, the C-SN 106A begins to operate as an SN to transmit data to the UE 102 and/or receive data from the UE 102.

As described above, the MN 104 configures C-PSCell(s)/the C-SN 106A to the UE 102 at events 304, 306, 308, 310 and 312 in advance, before the C-PSCell(s)/the C-SN 106 become suitable for the UE 102. When the C-PSCell(s)/the C-SN 106 becomes suitable for the UE 102, the UE 102 performs the random access procedure with the first C-PSCell with the C-SN 106A to quickly connect to the C-SN 106A. In contrast to the immediate SN Addition procedure, where a failed attempt to connect to the SN would require the MN to restart the procedure, the conditional SN addition technique discussed in this disclosure significantly reduces latency associated with DC configuration.

The RAN node interface message the C-SN 106A transmits 318 can be an X2 application protocol (AP) message or a Xn AP message. In some implementations, the RAN node interface message can be a SgNB Activity Notification message or Activity Notification message which explicitly indicates “re-activated”, “activated” or “connected”. In other implementations, the RAN node interface message can be a SgNB Modification Required message or a S-Node Modification Required message which explicitly indicates “re-activated,” “activated” or “connected.” In further implementations, the RAN node interface message can be an SgNB Modification Required message or an S-Node Modification Required message that implicitly indicates “re-activated,” “activated” or “connected” using an IE defined for another purpose or a dedicated IE specifically defined to indicate the status of the connection between a UE and an C-SN. In additional implementations, the RAN node interface message can be a SgNB Change Required message or a S-Node Change Required message that explicitly indicates “re-activated,” “activated” or “connected.” In still another implementation, the RAN node interface message can be a SgNB Change Required message or a S-Node Change Required message that implicitly indicates “re-activated,” “activated” or “connected” using an IE defined for another purpose or a dedicated IE specifically defined to convey the information discussed above.

In response to the RAN node interface message, the MN 104 can transmit 320 a SN Status Transfer message to the SN 106A, forward 322 data for the UE 102 received from the CN 110 to the SN 106A, and/or perform a path update procedure with the CN 110. In response to the path update procedure, the CN 110 starts sending data to the SN 106A instead of the MN 104. In some implementations, the MN 104 can send 320 the SN Status Transfer message if the MN 104 or the SN 106A configures an SN-terminated DRB for the UE 102. The MN 104 may not send the SN Status Transfer message if the MN 104 or the SN 106A does not configure a SN-terminated DRB for the UE 102. In other implementations, the SN 106A can ignore or discard the SN Status Transfer message if the MN 104 or the SN 106A does not configure a SN-terminated DRB for the UE 102. In further implementations, the SN 106A may ignore or discard content in the SN Status Transfer message for a SN-terminated DRB of the UE 102 if the SN-terminated DRB is not configured to use RLC acknowledged mode.

If the CN 110 is an EPC, the MN 104 may forward data received from S-GW 112 to the SN 106A and/or perform a path update procedure with the MME 114 and S-GW 112. In the path update procedure, the MN 104 sends an evolved radio access bearer (E-RAB) Modification Indication message to the MME 114. In response to the E-RAB Modification Indication message, the MME 114 sends a Bearer Indication message to the S-GW 112 and sends an E-RAB Modification Confirm message to the MN 104. In response to the Bearer Indication message, the S-GW 112 sends an End Marker Packet to the MN 104.

If the CN 110 is an 5GC, the MN 104 can forward data received from UPF 162 to the SN 106A and/or perform a path update procedure with the AMF 164 and UPF 162. In the path update procedure, the MN 104 sends a Protocol Data Unit (PDU) Session Modification Indication message to the AMF 164. In response to the PDU Session Modification Indication message, the AMF 164 sends a Bearer Indication message to the UPF 162 and sends an PDU Session Modification Confirm message to the MN 104. In response to the Bearer Indication message, the UPF 162 sends an End Marker Packet to the MN 104.

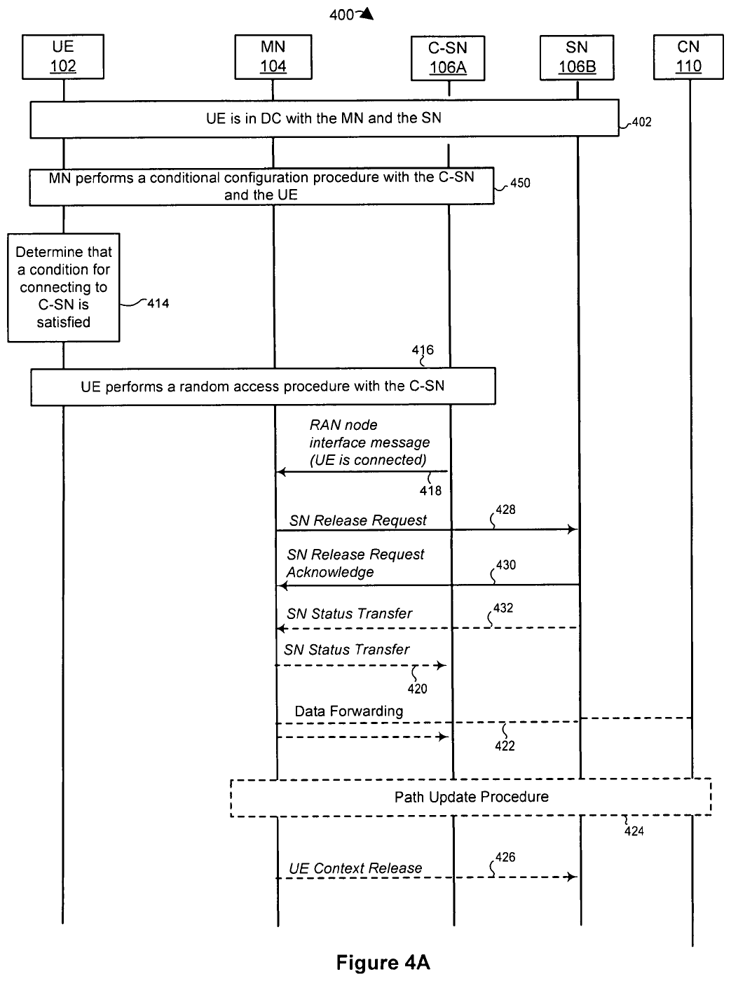

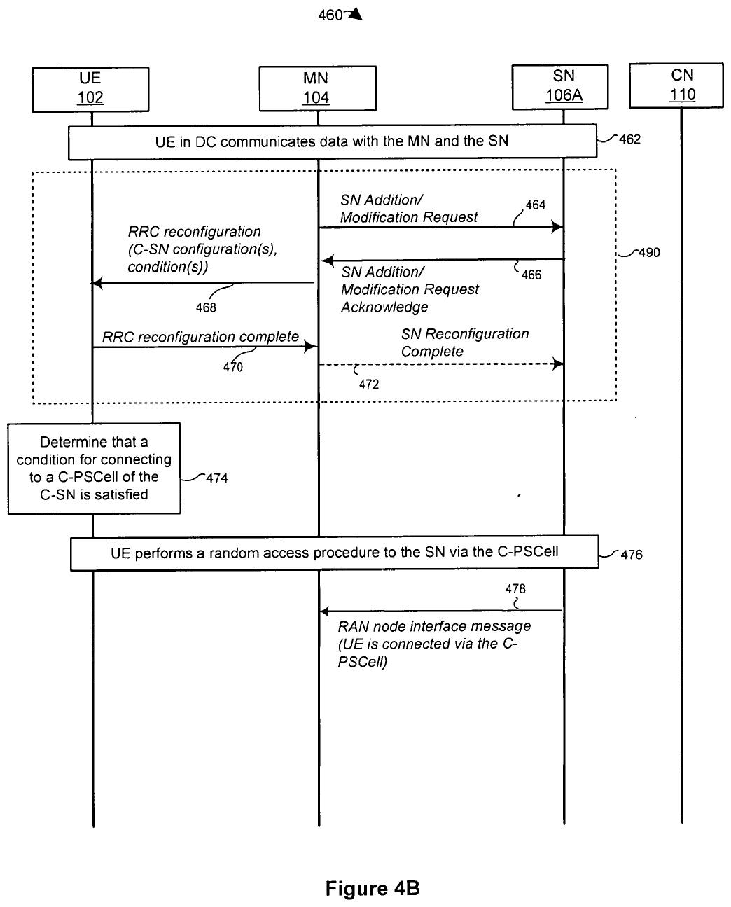

Next, FIG. 4A illustrates a scenario that involves a conditional SN Change, i.e., a conditional addition of a base station as an SN when the UE is already in DC with the MN and another base station. The BS 104 in this scenario operates as a MN, the BS 106B in this scenario operates as a SN and the BS 104A in this scenario operates as a C-SN for the UE 102. Events 402, 450, 415, 418 and 420 in this scenario are similar to events 302, 350, 314, 316, 318 and 320 discussed with reference to FIG. 3. The differences between the scenarios of FIG. 3 and FIG. 4A are discussed below.

In the scenario 400 of FIG. 4A, the MN 104 sends a SN Release Request message to the SN 106B in response to the RAN node interface message at event 418 and, in response, the SN 106B sends a SN Release Request Acknowledge message to the MN 104. In response to the SN Release Request message, the SN 106B may send 432 a SN Status Transfer message to the MN 104. The MN 104 may send 420 a SN Status Transfer message to the SN 106A. The MN 104 may include content in the SN Status Transfer message at event 432 in the SN Status Transfer message at event 420. In some implementations, the SN 106B may send 432 the SN Status Transfer message if the MN 104 or the SN 106B configures a SN-terminated data radio bearer (DRB) for the UE 102. The SN 106B may not send the SN Status Transfer message if the MN 104 or the SN 106B does not configure an SN-terminated DRB for the UE 102. In other implementations, the MN 104 or SN 106A may ignore or discard the SN Status Transfer message (event 420, 432) if the MN 104 or the SN 106A does not configure a SN-terminated DRB for the UE 102. In further implementations, the MN 104 or the SN 106A may ignore or discard content in the SN Status Transfer message (event 420, 432) for a SN-terminated DRB of the UE 102 if the SN-terminated DRB is not configured to use RLC acknowledged mode.

In some implementations, the SN 106B stops communicating data with the UE 102 in response to the SN Release Request message. After receiving the SN Release Request message, if the SN 106B receives data for the UE 102 from the CN 110 (e.g., S-GW 112 or UPF 162) the SN 106B may forward 422 the data to the MN 104. Then the MN 104 may forward 422 the data to the SN 106A.

In response to the RAN node interface message, the MN 104 can perform a path update procedure involving the CN 110 and the SN 106A. If the CN 110 is an EPC, the MN 104 may perform a path update procedure with the MME 114 and S-GW 112. During the path update procedure, the MN 104 sends an evolved radio access bearer (E-RAB) Modification Indication message to the MME 114. In response to the E-RAB Modification Indication message, the MME 114 sends a Bearer Indication message to the S-GW 112 and sends an E-RAB Modification Confirm message to the MN 104. In response to the Bearer Indication message, the S-GW 112 sends an End Marker Packet to the SN 106B, the SN 106B forwards the End Marker Packet to the MN 104, and the MN 104 forwards the End Marker Packet to the SN 106A. The S-GW 112 may send a New Path message to the SN 106B in response to the Bearer Modification message. In response to the E-RAB Modification Indication message, the MN 104 may send a UE Context Release message to the SN 106B.

If the CN 110 is an 5GC, the MN 104 may perform a path update procedure with the AMF 164 and UPF 162. In the path update procedure, the MN 104 sends an evolved PDU Session Modification Indication message to the AMF 164. In response to the PDU Session Modification Indication message, the AMF 164 sends a Bearer Indication message to the UPF 162 and sends an PDU Session Modification Confirm message to the MN 104. In response to the Bearer Indication message, the UPF 162 sends an End Marker Packet to the SN 106B, the SN 106B forwards the End Marker Packet to the MN 104, and the MN 104 forwards the End Marker Packet to the SN 106A. The UPF 112 may send a New Path message to the SN 106B in response to the Bearer Modification message. In response to the PDU Session Modification Indication message, the MN 104 may send a UE Context Release message to the SN 106B.

In some implementations, the SN 106A may stop 431 communicating data with the UE in response to the SN Release Request message, while or after transmitting the SN Release Request Acknowledge message. In some implementations, when the SN 106A stops 431 communicating data with the UE 102, the SN 106A determines the at least one first security key is no longer valid.

The scenario 460 of FIG. 4B is generally similar to the scenario of FIG. 4A, but in this case the UE 102 initially communicates 462 data in DC with the MN 104 and SN 106A. The MN 104 determines that the UE 102 should conditionally connect to the SN 106A via a new cell, the C-PSCell, of the SN 106A. To this end, the MN 104 can send 464 use the SN Addition request or an SN Modification request to the SN 106A, depending on the implementation, as a part of the conditional configuration procedure 490. The UE 102 later determines 474 that the one or more conditions for connecting to the C-PSCell of the SN 106A is satisfied, and performs 476 a random access procedure to the SN 105 via the C-PSCell. Thus, although the SN 106A already operates as an SN rather than a C-SN, the PSCell is a C-PSCell. In response to identifying the UE 102 as discussed above with reference to FIG. 3, the SN 106A sends 478 to the MN 104 a RAN node interface message indicating that the UE 102 is connected via the C-PSCell (in contrast to event 318, where the C-SN 106A indicates that the UE 102 is connected to the C-SN 106A rather than a particular cell).

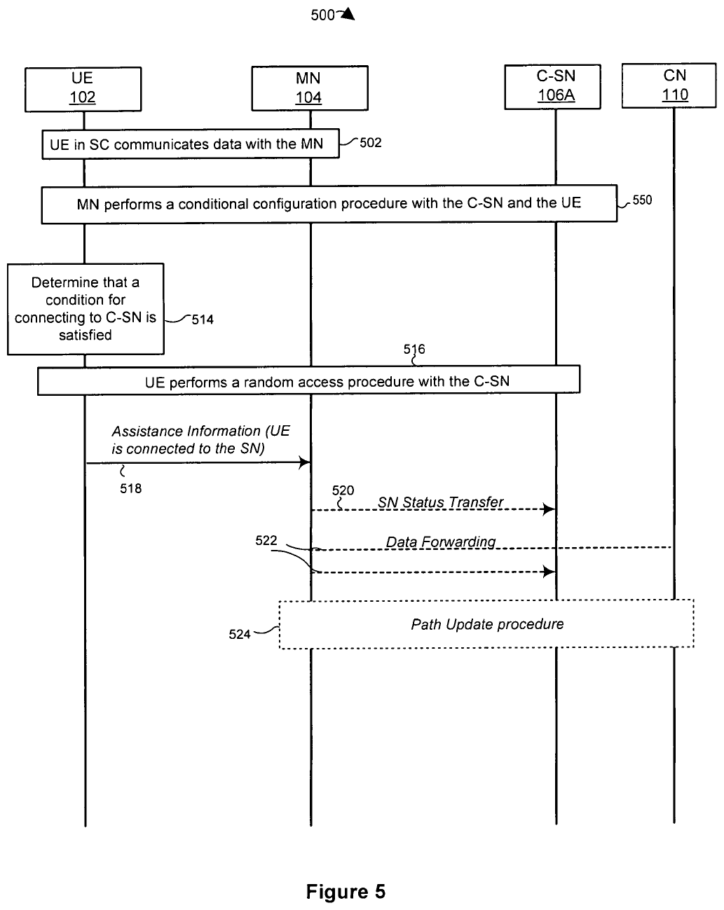

Next, FIG. 5 illustrates another scenario 500 that involves a conditional SN Addition similar to FIG. 3. The BS 104 in this scenario operates as a MN, the BS 106A in this scenario operates as a C-SN. Events 502, 550, 514, 516 520, 522 and 524 are similar to events 302, 350, 314, 316, 320, 322 and 324 discussed with reference to FIG. 3. The differences between the scenarios of FIG. 3 and FIG. 5 are considered below.

In the scenario 500, the UE 102 may send 518 the MN 104 an Assistance Information message indicating the UE is connected after detecting a condition of the condition(s) is satisfied for a first C-PSCell. In some implementations, the UE 102 may send 518 the Assistance Information message after completing a random access procedure on the first C-PSCell with the C-SN 106A at event 516. In other implementations, the UE 102 may send 518 the Assistance Information message during the random access procedure at event 516. In further implementations, the UE 102 may send 518 the Assistance Information message if detecting the condition at event 514.

The MN 104 may send the 520 a SN Status Transfer message to the C-SN 106A, forward 522 data for the UE 102 received from the CN 110 to the SN 106A, and/or perform a path update procedure with the CN 110, in response to the Assistance Information message.

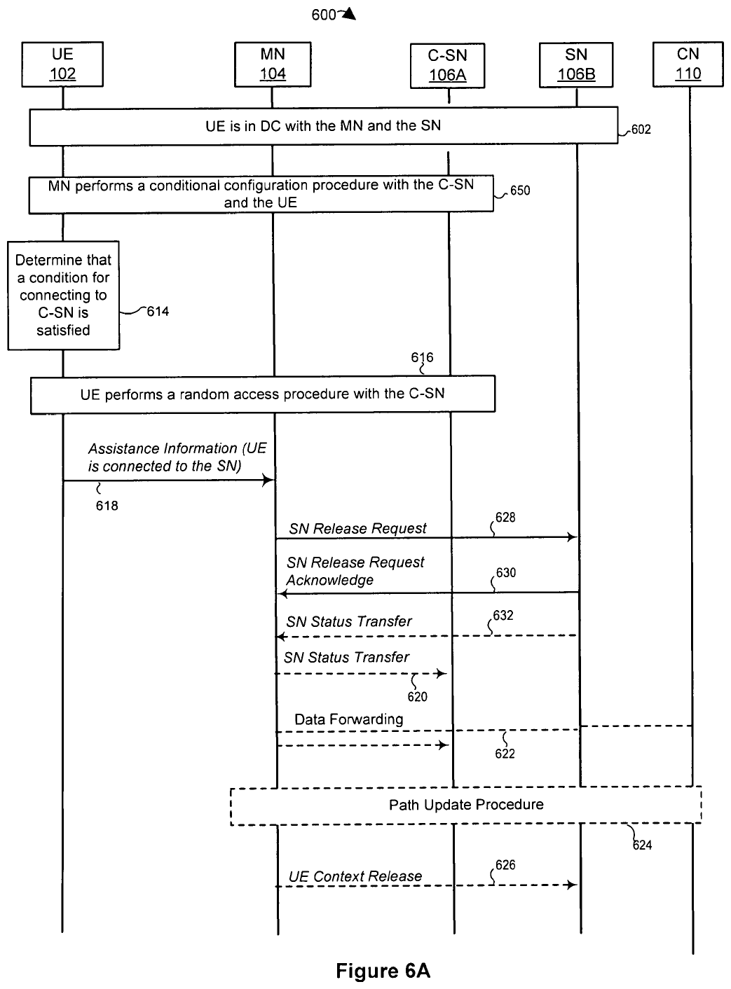

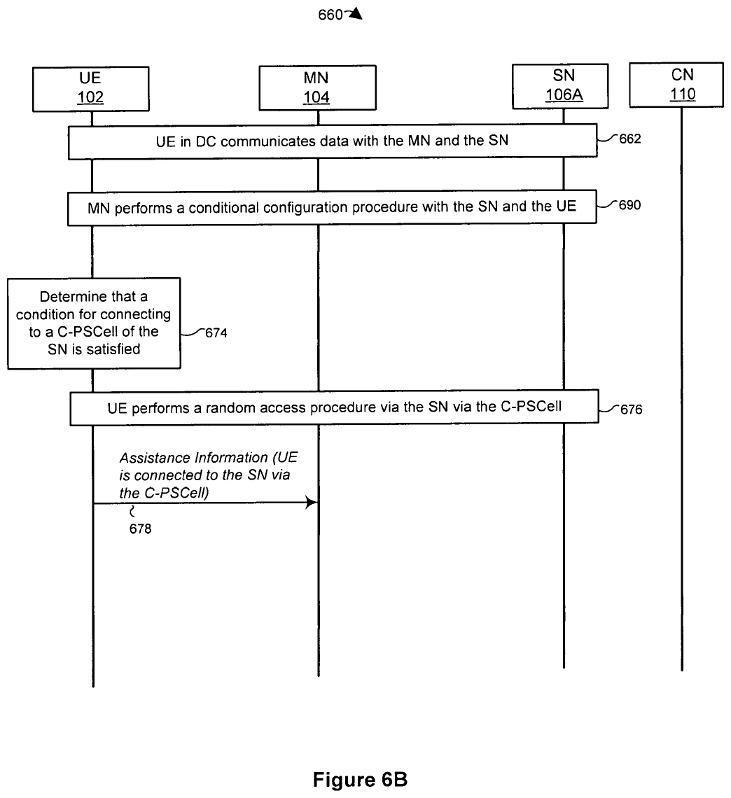

Next, FIG. 6A illustrates yet another scenario 600 that involves a conditional SN Change similar to FIG. 4A. The BS 104 in this scenario operates as a MN, the BS 106A in this scenario operates as a C-SN. Events 602, 650, 614, 616 620, 622, 624, 626, 628, 630, 632 are similar to events 402, 450, 414, 416, 420, 422, 424, 426, 428, 430, 332 discussed with reference to FIG. 4A. The differences between the FIG. 4A and FIG. 6A are discussed below.

In the scenario 600, the UE 102 may send 618 the MN 104 an Assistance Information message indicating the UE is connected after detecting a condition of the condition(s) is satisfied for a first C-PSCell. In some implementations, the UE 102 may send 618 the Assistance Information message after completing a random access procedure on the first C-PSCell with the C-SN 106A at event 616. In other implementations, the UE 102 may send 618 the Assistance Information message during the random access procedure at event 616. In further implementations, the UE 102 may send 618 the Assistance Information message if detecting the condition at event 614.

The MN 104 may send the 628 a SN Release Request message to the C-SN 106A in response to the Assistance Information message. The MN 104 may forward 622 data for the UE 102 received from the SN 106B (i.e., an old SN of the UE 102) to the C-SN 106A (i.e., a new SN of the UE 102) and perform a path update procedure involving the CN 110 and the SN 106A after receiving the Assistance Information message.

The scenario 660 of FIG. 6B is generally similar to the scenario of FIG. 6A, but, as in the scenario 460 of FIG. 4B, the UE 102 initially communicates 662 data in DC with the MN 104 and SN 106A. The MN 104 accordingly performs a conditional configuration procedure 690 similar to the procedure 490. The UE 102 later determines 674 that the one or more conditions for connecting to the C-PSCell of the SN 106A is satisfied, and performs 676 a random access procedure to the SN 106 via a new Cell, the C-PSCell. In the scenario 660, the UE 102 may send 678 the MN 104 an Assistance Information message indicating the UE is connected after detecting a condition of the condition(s) is satisfied for a C-PSCell. In some implementations, the UE 102 may send 678 the Assistance Information message after completing a random access procedure on the C-PSCell with the SN 106A at event 676. In other implementations, the UE 102 may send 678 the Assistance Information message during the random access procedure at event 676. In further implementations, the UE 102 may send 618 the Assistance Information message if detecting the condition at event 674.

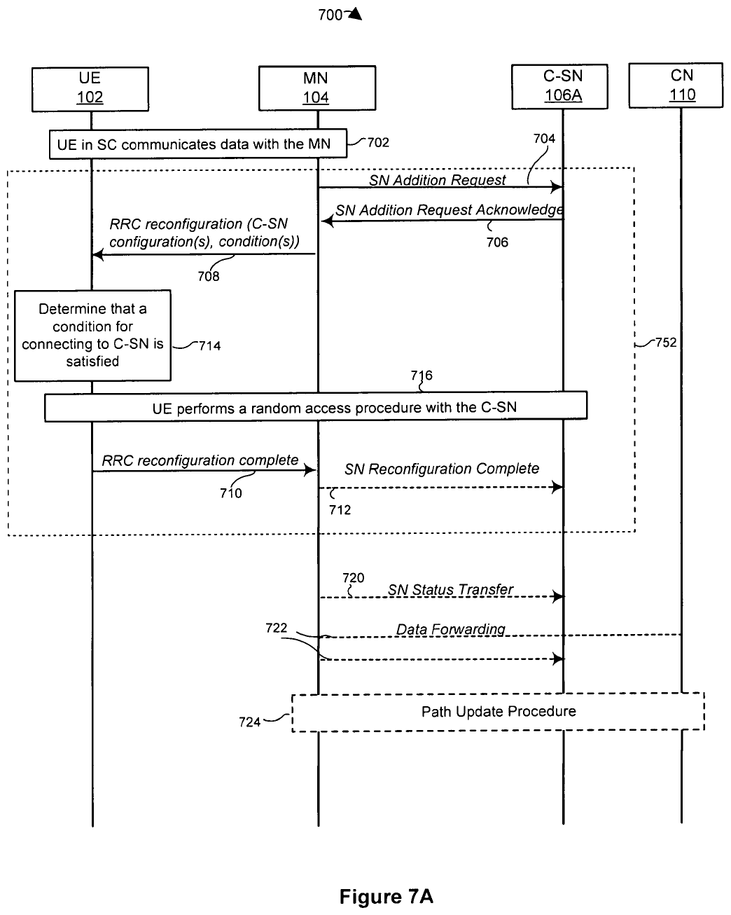

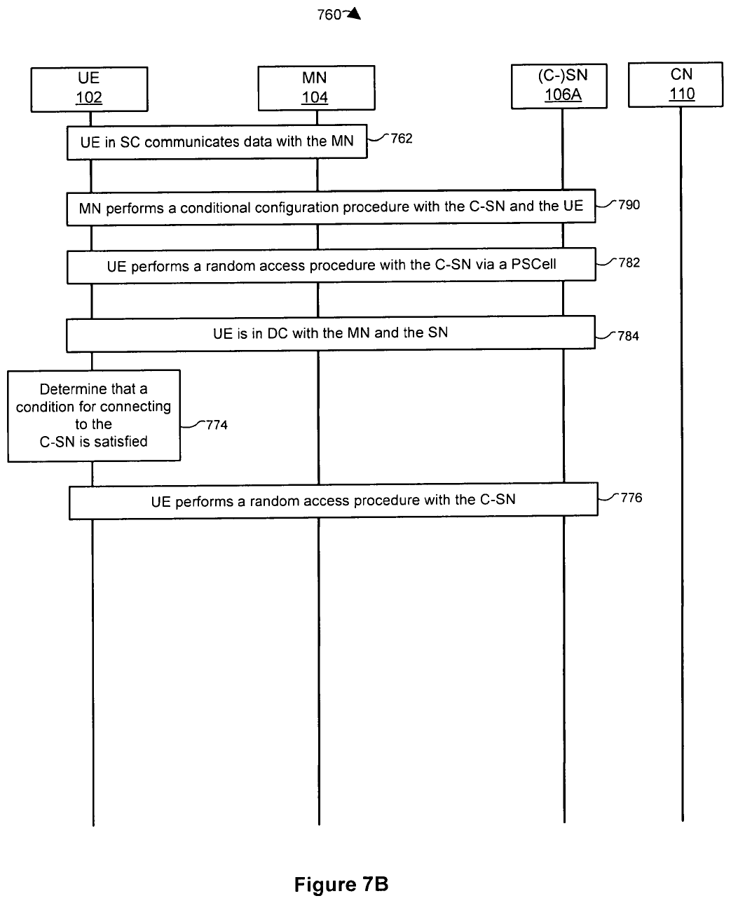

Referring to FIG. 7A, a scenario 700 also involves a conditional SN Addition, similar to the scenario 300 of FIG. 3. The BS 104 in this scenario operates as a MN, the BS 106A in this scenario operates as a C-SN. All the events in FIG. 7A are similar to all the events discussed with reference to FIG. 3, except for event 318. The differences between the FIG. 7A and FIG. 3 are discussed below.

In the scenario 700 of FIG. 7A, the UE 102 transmits 710 the first RRC reconfiguration complete message until the UE completes the random access procedure on the first C-PSCell with the C-SN 106A at event 716. In an alternative implementation, the UE 102 may transmit 710 the first RRC reconfiguration complete message during the random access procedure. In another alternative implementation, the UE 102 may transmit the 710 the first RRC reconfiguration complete message before the random access procedure upon detecting the condition in the set of one or more conditions is satisfied for the first C-PSCell.

Next, FIG. 7B still illustrates a similar scenario as the previous figures. Most description for the previous figures can be applied to FIG. 7B. The base station 104 in this scenario operates as a MN, the base station 106A in this scenario operates as a C-SN and a SN ((C-)SN) for the UE 102.

In the scenario of FIG. 7B, the UE 102 in SC with a MN 104 communicates 762 data (e.g., UL Data PDUs and/or DL Data PDUs) with MN 104. The MN 104 can determine to initiate an (immediate) SN Addition procedure to configure the base station 106A as a SN to the UE 102, e.g., based on measurement result(s) from the UE 102. In response to the determination, the MN 104 sends 764 a SN Addition Request message to the SN 106A for the purposes of the SN Addition procedure. In response to the Addition Request message, the SN 106A includes a SN configuration and first C-SN configuration(s) in an SN Addition Request Acknowledge message for the UE 102. The SN 106A sends 766 the SN Addition Request Acknowledge message to the MN 104 in response to the SN Addition Request message. The first C-SN configuration includes one or more configurations for at least one candidate primary secondary cell (C-PSCell(s)). The SN configuration can include configurations for a PSCell. In some implementations, the SN configuration may include a CellGroupConfig IE or SCG-ConfigPartSCG-r12 IE which configures physical layer configuration, MAC configuration and/or RLC configuration.

In response to the SN Addition Request Acknowledge message, the MN 104 includes the SN configuration, the first C-SN configuration(s) and condition(s) in a first RRC reconfiguration message and transmits 768 the first RRC reconfiguration message to the UE 102. The UE 102 transmits 770 a first RRC reconfiguration complete message to the MN 104 in response to the first RRC reconfiguration message. The MN 104 in some implementations may send 772 a SN Reconfiguration Complete message to the SN 106A in response to the RRC reconfiguration complete message. The condition(s) is used by the UE 102 to determine whether to connect to C-PSCell(s) of the SN 106A. If the UE 102 detects one of the condition(s) is satisfied, the UE connects to a first C-PSCell of the SN 106A. If the UE 102 detect none of the condition(s) for connecting the first C-PSCell is satisfied, the UE does not connect to the first C-PSCell of the SN 106A. In some implementations, the condition(s) may be specific for one, some or all of the first C-PSCell(s). If UE 102 detects one of the condition(s) for connecting to the first C-PSCell is satisfied, the UE 102 performs a random access procedure via the first C-PSCell with the SN 106A. If the UE 102 does not detect that none of the condition(s) for connecting to the first C-PSCell is satisfied, the UE 102 does not perform a random access procedure via the first C-PSCell with the SN 106A.

In response to the first RRC reconfiguration message or the SN configuration, the UE 102 performs 782 a random access procedure with the SN 106A via the PSCell. In response to the first RRC reconfiguration message, the SN configuration, the random access procedure or completion of the random access procedure, the UE is 784 in DC with the MN 104 and the SN 106A.

At a later time, the UE detects 774 a condition of the condition(s) for connecting to the first C-PSCell is satisfied and initiates 774 a random access procedure via the first C-PSCell with the SN 106A in response to the detection. The UE 102 performs 776 a random access procedure with the SN 106A via the first C-PSCell in response to the initiation. In some implementations, the SN 106A identifies the UE 102 in the random access procedure sends 776. In response to the identification, the SN 106A sends the MN 104 a RAN node interface message indicating the UE 102 is connected (to the first C-PSCell). In other implementations, the UE 102 sends an RRC reconfiguration complete message to the MN 104 as event 710 in FIG. 7A. The MN 104 may send a SN Reconfiguration Complete message in response to the RRC reconfiguration complete message as event 712 in FIG. 7A. In further implementations, the UE 102 may send an Assistance Information message to the MN 104 as event 518. In additional implementations, the UE 102 neither sends the RRC reconfiguration complete message nor the Assistance Information message to the MN 104.

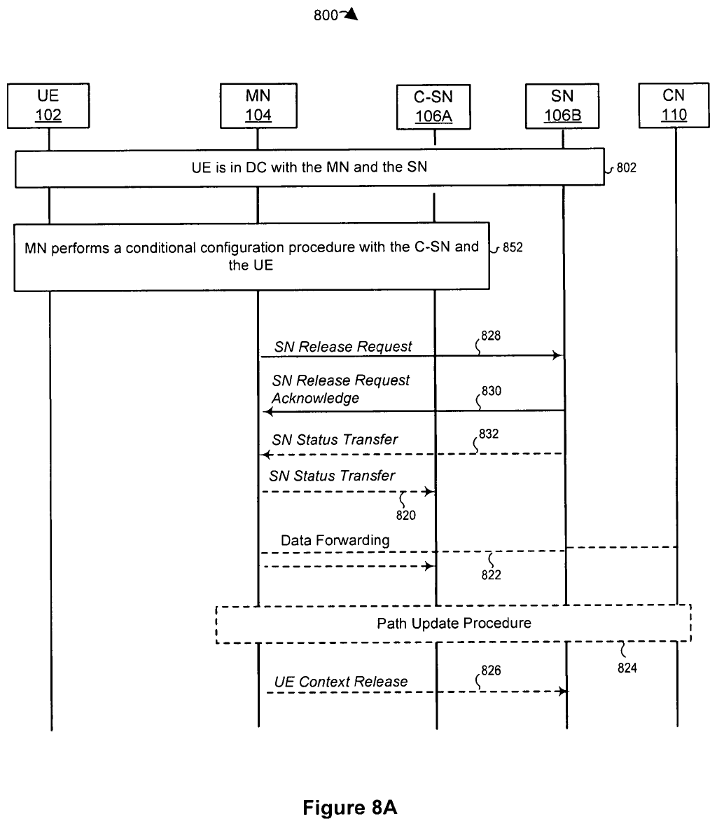

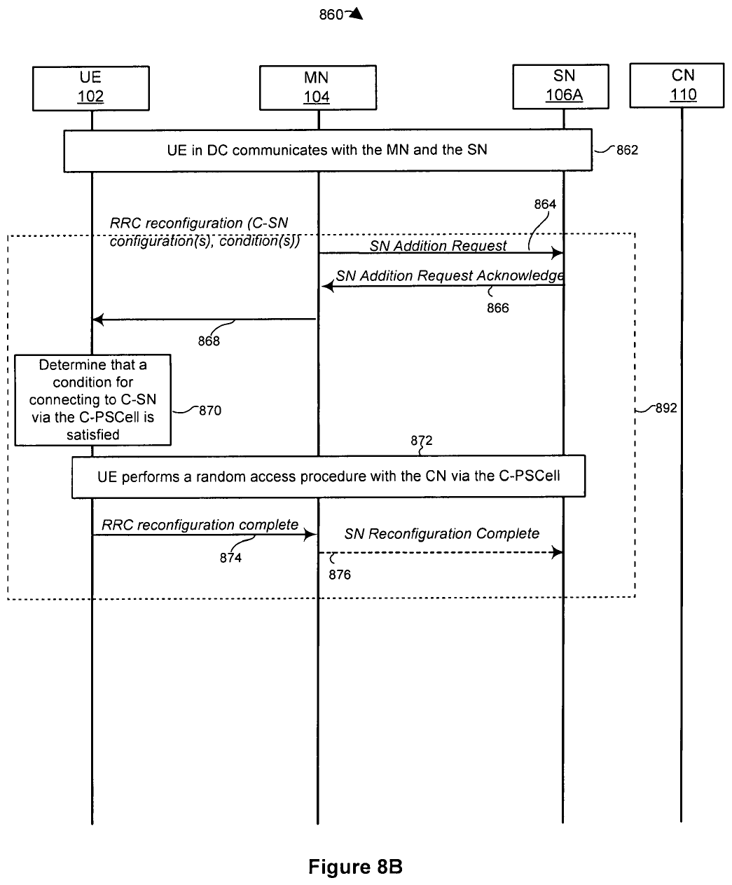

FIG. 8A illustrates a scenario 800 also related to a conditional SN Change discussed with reference to FIG. 4A. The BS 104 in this scenario operates as a MN, the BS 106A in this scenario operates as a C-SN. All the events in FIG. 8A are similar to all the events of the scenario of FIG. 4A, except for event 418. The differences between FIG. 8A and FIG. 4A are considered below.

In the scenario of FIG. 8A, the UE 102 transmits 810 the first RRC reconfiguration complete message until the UE completes the random access procedure on the first C-PSCell with the C-SN 106A at event 816. In an alternative implementation, the UE 102 may transmit 810 the first RRC reconfiguration complete message during the random access procedure. In another alternative implementation, the UE 102 may transmit the 810 the first RRC reconfiguration complete message before the random access procedure upon detecting the condition in the set of one or more conditions is satisfied for the first C-PSCell.

The scenario 860 of FIG. 8B is generally similar to the scenario of FIG. 8A, but in this case the UE 102 initially communicates 862 data in DC with the MN 104 and SN 106A. Thus, similar to the scenario of FIG. 4B, the MN 104 determines that the UE 102 should conditionally connect to the SN 106A via a new cell, the C-PSCell, of the SN 106A. A conditional configuration procedure 892 in this case includes the UE 102 determining 872 that the one or more conditions for connecting to the C-PSCell of the SN 106A is satisfied, and performing 872 a random access procedure to the SN 105 via the C-PSCell.

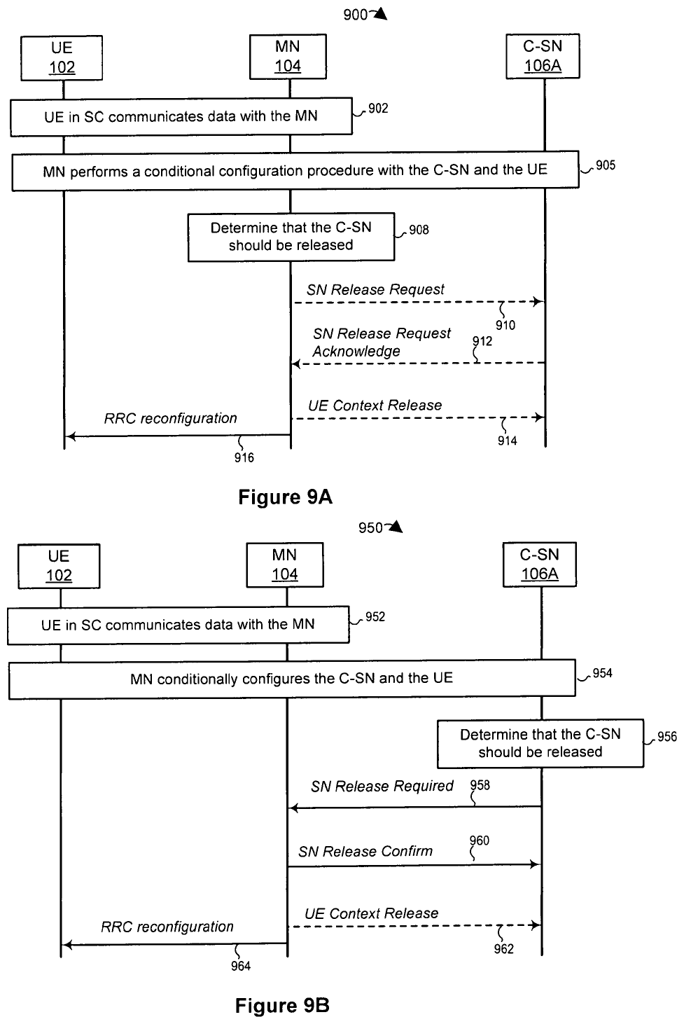

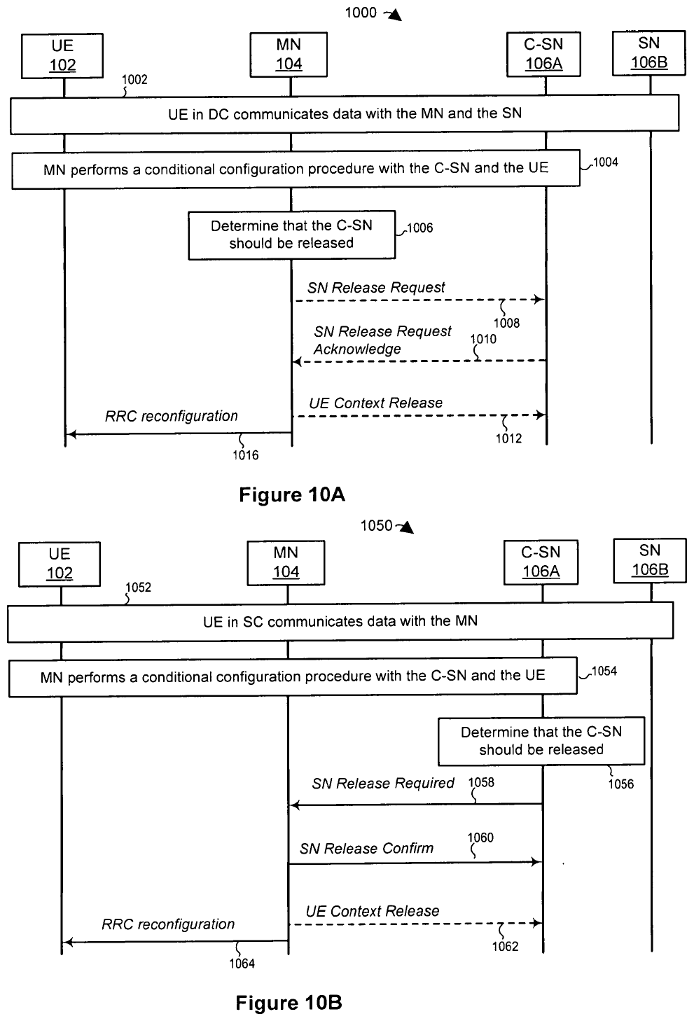

Next, several example scenarios in which the MN 104 initiates a conditional SN Release procedure are discussed with reference to FIGS. 9A-10B.

Referring first to FIG. 9A, the base station 104 in this scenario operates as a MN and the base station 106A in this scenario operates as a C-SN. Initially, the UE 102 in SC communicates 902 data with the MN 104. At event 905, the MN 104 configures the base station 106A as the C-SN for the UE 102 as described for event 350, 550, (704, 706, 708). Then the MN 104 determines 908 to release the C-SN 106A for the UE 102. In some implementations, the MN 104 may send 910 a SN Release Request message to the C-SN 106A in response to the determination. In response to the SN Release Request message, the C-SN 106A may send 912 a SN Release Request Acknowledge message to the MN 104. The MN 104 may send 914 a UE Context Release message to the C-SN 106A in response to the determination or in response to the SN Release Request message. The first C-SN 106A releases the first C-SN configuration(s) configured to the UE 102 in response to the SN Release Request message or the UE Context Release message. In other implementations, the MN 104 may send 914 a UE Context Release message to the C-SN 106A in response to the determination without sending the SN Release Request message. The C-SN 106A releases the first C-SN configuration(s) configured to the UE 102 in response to the UE Context Release message. The MN 104 may send 916 a second RRC reconfiguration message to the UE 102 to release the first C-SN configuration(s) in response to the determination or the SN Release Request Acknowledge message. In other words, the MN 104 may transmit the second RRC reconfiguration message before, during or after events 910, 912, 914.

The MN 104 may release the condition(s) in response to the determination or the SN Release Request Acknowledge message. The UE 102 may release the first C-SN configuration(s) and/or condition(s) and transmit a second RRC reconfiguration complete message to the MN 104, in response to the second RRC reconfiguration message. The UE 102 may transmit a second RRC reconfiguration complete message to the MN 104 in response to the second RRC reconfiguration message.

In some implementations, the second RRC reconfiguration message includes an IE indicating the UE to release the first C-SN configuration(s). In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message.

In some implementations, the MN 104 may determine to release the C-SN 106A for the UE 102 in response to a handover decision for the UE 102. In other implementations, the MN 104 may determine to release the C-SN 106A for the UE 102 in response to one or measurement results received from the UE. The one or more measurement results may indicate that the UE 102 detects bad signal strength/quality on cell(s) (e.g., C-PSCell(s)) of the C-SN 106A. For example, the MN 104 may determine to release the C-SN 106A for the UE 102 if the MN 104 determines the UE 102 detects bad signal strength/quality on the cell(s) (e.g., C-PSCell(s)) of the C-SN 106A from one or more measurement results received from the UE 102.

In some implementations, the MN 104 may skip events 910, 912 and 914. In some implementations, the C-SN 106A may start a timer in response to providing the first C-SN configuration(s) to the UE 102 as events 350, 550 and (704, 706, 708). The C-SN 106A releases the C-SN configuration(s) upon expiry of the timer. Thus, even without the events 910, 912 and 914, the C-SN 106A can release the first C-SN configuration(s) once the timer expires.

Now referring to FIG. 9B, the base station 104 in this scenario operates as a MN and the base station 106A in this scenario operates as a C-SN. The UE 102 initially communicates 952 in SC with the MN 104. At event 954, the MN 104 configures the base station 106A as the C-SN for the UE 102 as described for event 350, 550, (704, 706, 708). Then the C-SN 106A determines 956 to release the itself for the UE 102. The SN 106A may send 958 a SN Release Required message to the MN 104 in response to the determination. In response to the SN Release Required message, the MN 104 may send 960 a SN Release Confirm message to the SN 106A. The MN 104 may or may not send 962 a UE Context Release message to the C-SN 106A in response to the SN Release Required message. The first C-SN 106A releases the first C-SN configuration(s) configured to the UE 102 in response to the determination, the SN Release Confirm message or the UE Context Release message. The C-SN 106A releases the first C-SN configuration(s) configured to the UE 102 in response to the UE Context Release message. The MN 104 may release the condition(s) configured to the UE 102 in response to the SN Release Required message. The MN 104 may send 964 a second RRC reconfiguration message to the UE 102 to release the first C-SN configuration(s) in response to the SN Release Required message. The UE 102 may release the first C-SN configuration(s) and/or condition(s) and transmit a second RRC reconfiguration complete message to the MN 104, in response to the second RRC reconfiguration message.

In some implementations, the second RRC reconfiguration message includes an IE indicating the UE to release the first C-SN configuration(s). In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message.

In some implementations, the C-SN 106A may determine to release the C-SN 106A for the UE 102 upon expiry of a timer. The SN 106A may start the timer in response to providing the first C-SN configuration(s) to the UE 102 via the MN 104. In other implementations, the C-SN 106 may determine to release the C-SN 106A for the UE 102 if the C-SN 106 detects congestion or has limited resources available.

FIG. 10A depicts another scenario 1000 that involves a conditional SN Release procedure. The base station 104 in this scenario operates as a MN, the base station 106A in this scenario operates as a C-SN and the base station 106B in this scenario operates as a SN. Initially, the UE 102 in DC communicates 1002 data with the MN 104 and the SN 106B. At event 1004, the MN 104 configures the base station 106A as the C-SN for the UE 102 as described for event 450, 650, (804, 806, 808). Then the MN 104 determines 1006 to release the C-SN 106A for the UE 102. In some implementations, the MN 104 may send 1008 a SN Release Request message to the C-SN 106A in response to the determination. In response to the SN Release Request message, the C-SN 106A may send 1010 a SN Release Request Acknowledge message to the MN 104. The MN 104 may send 1012 a UE Context Release message to the C-SN 106A in response to the determination or in response to the SN Release Request message. The first C-SN 106A releases the first C-SN configuration(s) configured to the UE 102 in response to the SN Release Request message or the UE Context Release message. In other implementations, the MN 104 may send 1012 a UE Context Release message to the C-SN 106A in response to the determination without sending the SN Release Request message. The C-SN 106A releases the first C-SN configuration(s) configured to the UE 102 in response to the UE Context Release message. The MN 104 may send 1014 a second RRC reconfiguration message to the UE 102 to release the first C-SN configuration(s) in response to the determination or the SN Release Request Acknowledge message. In other words, the MN 104 may transmit the second RRC reconfiguration message before, during or after events 1008, 1010, 1012.

The MN 104 may release the condition(s) in response to the determination or the SN Release Request Acknowledge message. The UE 102 may release the first C-SN configuration(s) and/or condition(s) and transmit a second RRC reconfiguration complete message to the MN 104, in response to the second RRC reconfiguration message. The UE 102 may transmit a second RRC reconfiguration complete message to the MN 104 in response to the second RRC reconfiguration message.

In some implementations, the second RRC reconfiguration message includes an IE indicating the UE to release the first C-SN configuration(s). In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message.

In some implementations, the MN 104 may determine to release the C-SN 106A for the UE 102 in response to a handover decision for the UE 102. In other implementations, the MN 104 may determine to release the C-SN 106A for the UE 102 in response to one or measurement results received from the UE. The one or more measurement results may indicate that the UE 102 detects bad signal strength/quality on cell(s) (e.g., C-PSCell(s)) of the C-SN 106A. For example, the MN 104 may determine to release the C-SN 106A for the UE 102 if the MN 104 determines the UE 102 detects bad signal strength/quality on the cell(s) (e.g., C-PSCell(s)) of the C-SN 106A from one or more measurement results received from the UE 102.

In some implementations, the MN 104 may skip events 1008, 1010 and 1012. In some implementations, the C-SN 106A may start a timer in response to providing the first C-SN configuration(s) to the UE 102 as events 450, 650 and (804, 806, 708). The C-SN 106A releases the C-SN configuration(s) upon expiry of the timer. Thus, even without the events 1008, 1010 and 1012, the C-SN 106A can release the first C-SN configuration(s) once the timer expires.

In some implementations, the UE 102 is still in DC with the MN 104 and the SN 106B during or after events 1008, 1010, 1012 or 1016. In other implementations, the MN 104 may perform an (immediate) SN Release procedure with the SN 106B during or after events 1008, 1010, 1012 or 1016 to release the SN 106B for the UE 102. In further implementations, the MN 104 may perform an (immediate) SN Modification procedure with the SN 106B during or after events 1008, 1010, 1012 or 1016 to reconfiguration radio resources of the SN 106B for the UE 102. In additional implementations, the MN 104 may perform an (immediate) SN Addition procedure with a base station (e.g., base station 108 not shown in FIG. 1) during or after events 1008, 1010, 1012 or 1016 to change configure the base station as a new SN for the UE 102.

Now referring to FIG. 10B, the base station 104 in the scenario 1060 operates as a MN, the base station 106A in this scenario operates as a C-SN and the base station 106B in this scenario operates as a SN. At beginning, the UE 102 in DC communicates 1052 with the MN 104 and the SN 106B. At event 1054, the MN 104 configures the base station 106A as the C-SN for the UE 102 as described for event 450, 650, (804, 806, 808). Then the C-SN 106A determines 1056 to release the itself for the UE 102. The SN 106A may send 1058 a SN Release Required message to the MN 104 in response to the determination. In response to the SN Release Required message, the MN 104 may send 1060 a SN Release Confirm message to the SN 106A. The MN 104 may or may not send 1062 a UE Context Release message to the C-SN 106A in response to the SN Release Required message. The first C-SN 106A releases the first C-SN configuration(s) configured to the UE 102 in response to the determination, the SN Release Confirm message or the UE Context Release message. The C-SN 106A releases the first C-SN configuration(s) configured to the UE 102 in response to the UE Context Release message. The MN 104 may release the condition(s) configured to the UE 102 in response to the SN Release Required message. The MN 104 may send 1064 a second RRC reconfiguration message to the UE 102 to release the first C-SN configuration(s) in response to the SN Release Required message. The UE 102 may release the first C-SN configuration(s) and/or condition(s) and transmit a second RRC reconfiguration complete message to the MN 104, in response to the second RRC reconfiguration message.

In some implementations, the second RRC reconfiguration message includes an IE indicating the UE to release the first C-SN configuration(s). In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message.

In some implementations, the C-SN 106A may determine to release the C-SN 106A for the UE 102 upon expiry of a timer. The SN 106A may start the timer in response to providing the first C-SN configuration(s) to the UE 102 via the MN 104. In other implementations, the C-SN 106 may determine to release the C-SN 106A for the UE 102 if the C-SN 106 detects congestion or has limited resources available.

In some implementations, the UE 102 is still in DC with the MN 104 and the SN 106B during or after events 1058, 1060, 1062 or 1064. In other implementations, the MN 104 may perform an (immediate) SN Release procedure with the SN 106B during or after events 1058, 1060, 1062 or 1064 to release the SN 106B for the UE 102. In further implementations, the MN 104 may perform an (immediate) SN Modification procedure with the SN 106B to reconfiguration radio resources of the SN 106B for the UE 102 during or after events 1058, 1060, 1062 or 1064. In additional implementations, the MN 104 may perform an (immediate) SN Addition procedure with a base station (e.g., base station 108 not shown in FIG. 1) to change configure the base station as a new SN for the UE 102 during or after events 1058, 1060, 1062 or 1064.

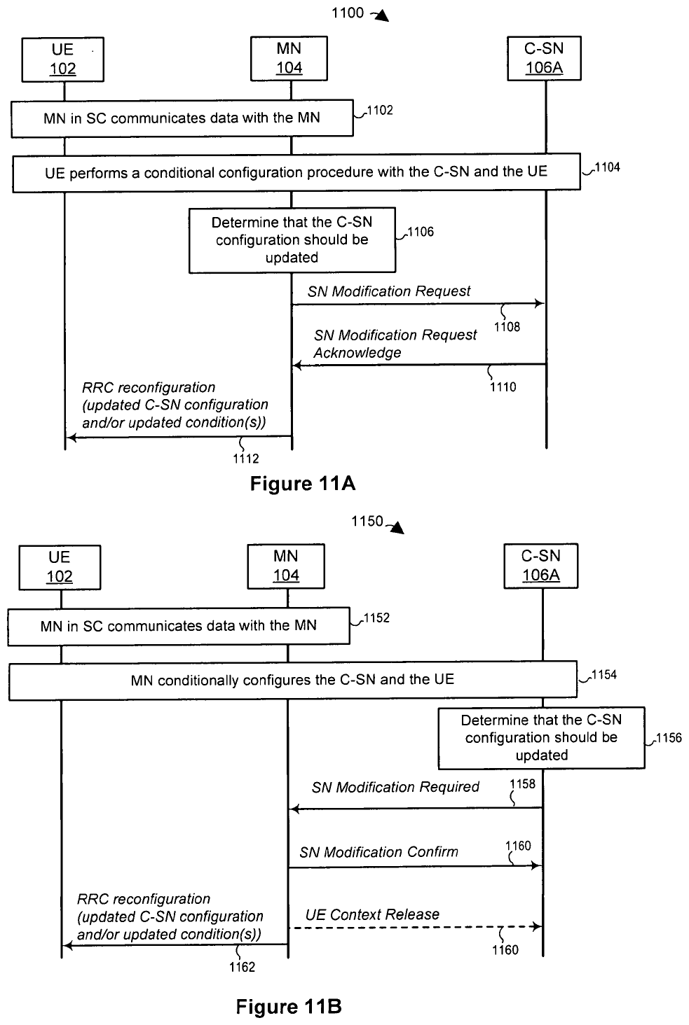

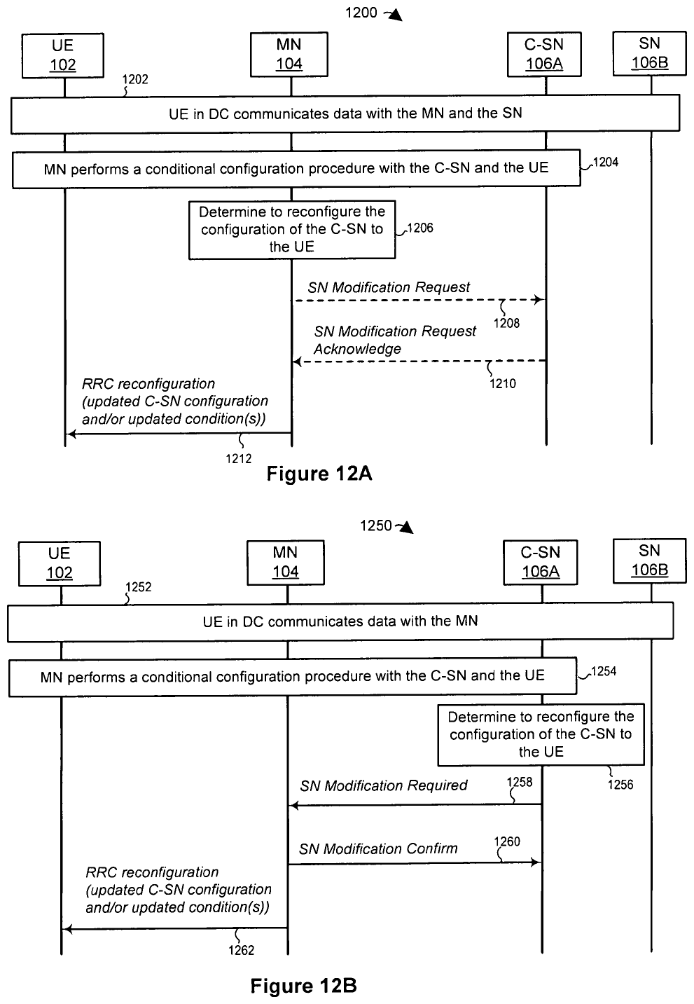

Next, several example scenarios in which the MN 104 initiates a conditional SN Modification procedure are discussed with reference to FIGS. 11A-12B.

Referring first to FIG. 11A, the base station 104 in a scenario 1100 operates as a MN and the base station 106A in this scenario operates as a C-SN. Initially, the UE 102 in SC communicates 1102 data with the MN 104. At event 1104, the MN 104 configures the base station 106A as the C-SN for the UE 102 as described for event 350, 550, (704, 706, 708). Then the MN 104 determines 1106 to update the first C-SN configuration(s) for the UE 102. In some implementations, the MN 104 may send 1108 a SN Modification Request message to the C-SN 106A in response to the determination. In response to the SN Modification Request message, the C-SN 106A may send 1110 a SN Modification Request Acknowledge message to the MN 104. In some implementations, the first C-SN 106A may update the first C-SN configuration(s) configured to the UE 102 and includes the updated first C-SN configuration(s) in the SN Modification Request Acknowledge message, in response to the SN Modification Request message. The MN 104 may send 1112 the UE 102 a second RRC reconfiguration message including the updated first C-SN configuration(s) to update the first C-SN configuration(s) in response to the SN Modification Request Acknowledge message. In some implementations, the UE 102 updates the first C-SN configuration(s) according to the updated C-SN configuration(s). The updated first C-SN configuration(s) may include a new configuration, release a configuration in the first C-SN configuration(s) or reconfigure a configuration in the first C-SN configuration(s). In other implementations, the UE replaces the first C-SN configuration(s) with the updated first C-SN configuration(s).

The UE 102 may or may not transmit a second RRC reconfiguration complete message to the MN 104 in response to the second RRC reconfiguration message.

In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message or because the UE 102 does not transmit the second RRC reconfiguration complete message.

In some implementations, the MN 104 may determine to update the first C-SN configuration(s) for the UE 102 because the MN 104 reconfigures a configuration configured to the UE 102 or because the MN 104 receives an updated UE capability from the UE 102. For example, the configuration may be a radio bearer configuration. The MN 104 may reconfigure the radio bearer configuration due to releasing a radio bearer for the UE 102. The MN 104 may include the reconfigured radio bearer configuration in the SN Modification Request message so that the C-SN 106A may generate the updated first C-SN configuration(s). In other implementations, the MN 104 may determine to update the first C-SN configuration(s) for the UE 102 in response to one or measurement results received from the UE. The one or more measurement results may indicate that the UE 102 detects signal strength/quality of new cell(s) or the C-PSCell(s) of the C-SN 106A. For example, the MN 104 may determine to request the C-SN 106A to configure a new cell as a new C-PSCell for the UE 102 if the MN 104 determines the UE 102 detects good signal strength/quality (e.g., above a first predetermined threshold) on the new cell from the one or more measurement results received from the UE 102. In another example, the MN 104 may determine to request the C-SN 106A to release a C-PSCell for the UE 102 if the MN 104 determines the UE 102 detects bad signal strength/quality (e.g., below a second predetermined threshold) on the C-PSCell cell from the one or more measurement results received from the UE 102. The first and second predetermined thresholds may be same or different.

Now referring to FIG. 11B, the base station 104 in this scenario operates as a MN and the base station 106A in this scenario operates as a C-SN. Initially, the UE 102 in SC communicates 1152 data with the MN 104. At event 1154, the MN 104 configures the base station 106A as the C-SN for the UE 102 as described for event 350, 550, (704, 706, 708). Then the C-SN 106A determines 1156 to update the first C-SN configuration(s) for the UE 102. In some implementations, the C-SN 106A may send 1108 a SN Modification Required message to the C-SN 106A in response to the determination. In response to the SN Modification Required message, the MN 104 may send 1160 a SN Modification Confirm message to the C-SN 106A. In some implementations, the first C-SN 106A may update the first C-SN configuration(s) configured to the UE 102 and includes the updated first C-SN configuration(s) in the SN Modification Required message. The MN 104 may send 1162 the UE 102 a second RRC reconfiguration message including the updated first C-SN configuration(s) to update the first C-SN configuration(s) in response to the SN Modification Required message. The UE 102 updates the first C-SN configuration(s) according to the updated C-SN configuration(s). The updated first C-SN configuration(s) may include a new configuration, release a configuration in the first C-SN configuration(s) or reconfigure a configuration in the first C-SN configuration(s). The UE 102 may or may not transmit a second RRC reconfiguration complete message to the MN 104 in response to the second RRC reconfiguration message.

In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message or because the UE 102 does not transmit the second RRC reconfiguration complete message.

In some implementations, the C-SN 106A may determine to update the first C-SN configuration(s) for the UE 102 because the C-SN 106A reconfigures a configuration configured to the UE 102, because the C-SN 106A receives an updated UE capability from the UE 102 or because the C-SN 106A is congested or has limited resources.

Referring to FIG. 12A, the base station 104 in a scenario 1200 operates as a MN, the base station 106A in this scenario operates as a C-SN and the base station 106B in this scenario operates as a SN. At beginning, the UE 102 in DC communicates 1202 data with the MN 104 and the SN 106B. At event 1204, the MN 104 configures the base station 106A as the C-SN for the UE 102 as described for event 450, 650, (804, 806, 808). Then the MN 104 determines 1206 to update the first C-SN configuration(s) for the UE 102. In some implementations, the MN 104 may send 1208 a SN Modification Request message to the C-SN 106A in response to the determination. In response to the SN Modification Request message, the C-SN 106A may send 1210 a SN Modification Request Acknowledge message to the MN 104. In some implementations, the first C-SN 106A may update the first C-SN configuration(s) configured to the UE 102 and includes the updated first C-SN configuration(s) in the SN Modification Request Acknowledge message, in response to the SN Modification Request message. The MN 104 may send 1212 the UE 102 a second RRC reconfiguration message including the updated first C-SN configuration(s) to update the first C-SN configuration(s) in response to the SN Modification Request Acknowledge message. The UE 102 updates the first C-SN configuration(s) according to the updated C-SN configuration(s). The updated first C-SN configuration(s) may include a new configuration, release a configuration in the first C-SN configuration(s) or reconfigure a configuration in the first C-SN configuration(s). The UE 102 may or may not transmit a second RRC reconfiguration complete message to the MN 104 in response to the second RRC reconfiguration message.

In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message or because the UE 102 does not transmit the second RRC reconfiguration complete message.

In some implementations, the MN 104 may determine to update the first C-SN configuration(s) for the UE 102 because the MN 104 reconfigures a configuration configured to the UE 102 or because the MN 104 receives an updated UE capability from the UE 102. In other implementations, the MN 104 may determine to update the first C-SN configuration(s) for the UE 102 in response to one or measurement results received from the UE. The one or more measurement results may indicate that the UE 102 detects signal strength/quality of new cell(s) or the C-PSCell(s) of the C-SN 106A. For example, the MN 104 may determine to request the C-SN 106A to configure a new cell as a new C-PSCell for the UE 102 if the MN 104 determines the UE 102 detects good signal strength/quality (e.g., above a first predetermined threshold) on the new cell from the one or more measurement results received from the UE 102. In another example, the MN 104 may determine to request the C-SN 106A to release a C-PSCell for the UE 102 if the MN 104 determines the UE 102 detects bad signal strength/quality (e.g., below a second predetermined threshold) on the C-PSCell cell from the one or more measurement results received from the UE 102. The first and second predetermined thresholds may be same or different.

In some implementations, the UE 102 is still in DC with the MN 104 and the SN 106B during or after events 1208, 1210 or 1212. In other implementations, the MN 104 may perform an (immediate) SN Release procedure with the SN 106B to release the SN 106B for the UE 102 during or after events 1218, 1210 or 1212. In further implementations, the MN 104 may perform an (immediate) SN Modification procedure with the SN 106B during or after events 1208, 1210 or 1212 to reconfiguration radio resources of the SN 106B for the UE 102. In additional implementations, the MN 104 may perform an (immediate) SN Addition procedure with a base station (e.g., base station 108 not shown in FIG. 1) during or after events 1208, 1210 or 1212 to change configure the base station as a new SN for the UE 102.

Referring to FIG. 12B, the base station 104 in a scenario 1250 operates as an MN, the base station 106A in this scenario operates as a C-SN and the base station 106B in this scenario operates as a SN. At beginning, the UE 102 in DC communicates 1252 data with the MN 104 and the SN 106B. At event 1254, the MN 104 configures the base station 106A as the C-SN for the UE 102 as described for event 450, 650, (804, 806, 808). Then the C-SN 106A determines 1256 to update the first C-SN configuration(s) for the UE 102. In some implementations, the C-SN 106A may send 1258 a SN Modification Required message to the C-SN 106A in response to the determination. In response to the SN Modification Required message, the MN 104 may send 1260 a SN Modification Confirm message to the C-SN 106A. In some implementations, the first C-SN 106A may update the first C-SN configuration(s) configured to the UE 102 and includes the updated first C-SN configuration(s) in the SN Modification Required message. The MN 104 may send 1262 the UE 102 a second RRC reconfiguration message including the updated first C-SN configuration(s) to update the first C-SN configuration(s) in response to the SN Modification Required message. The UE 102 updates the first C-SN configuration(s) according to the updated C-SN configuration(s). The updated first C-SN configuration(s) may include a new configuration, release a configuration in the first C-SN configuration(s) or reconfigure a configuration in the first C-SN configuration(s). The UE 102 may or may not transmit a second RRC reconfiguration complete message to the MN 104 in response to the second RRC reconfiguration message.

In some implementations, the MN 104 may send a SN Reconfiguration Complete message to the C-SN 106A in response to the second RRC reconfiguration complete message. In other implementations, the MN 104 may not send a SN Reconfiguration Complete message to the C-SN 106A in response to the second RRC reconfiguration complete message or because the UE 102 does not transmit the second RRC reconfiguration complete message.

In some implementations, the C-SN 106A may determine to update the first C-SN configuration(s) for the UE 102 because the C-SN 106A reconfigures a configuration configured to the UE 102, because the C-SN 106A receives an updated UE capability from the UE 102 or because the C-SN 106A is congested or has limited resources.

In some implementations, the UE 102 is still in DC with the MN 104 and the SN 106B during or after events 1258, 1260 or 1262. In other implementations, the MN 104 may perform an (immediate) SN Release procedure with the SN 106B to release the SN 106B for the UE 102 during or after events 1258, 1260 or 1262. In further implementations, the MN 104 may perform an (immediate) SN Modification procedure with the SN 106B during or after events 1258, 1260 or 1262 to reconfiguration radio resources of the SN 106B for the UE 102. In additional implementations, the MN 104 may perform an (immediate) SN Addition procedure with a base station (e.g., base station 108 not shown in FIG. 1) during or after events 1258, 1260 or 1262 to change configure the base station as a new SN for the UE 102

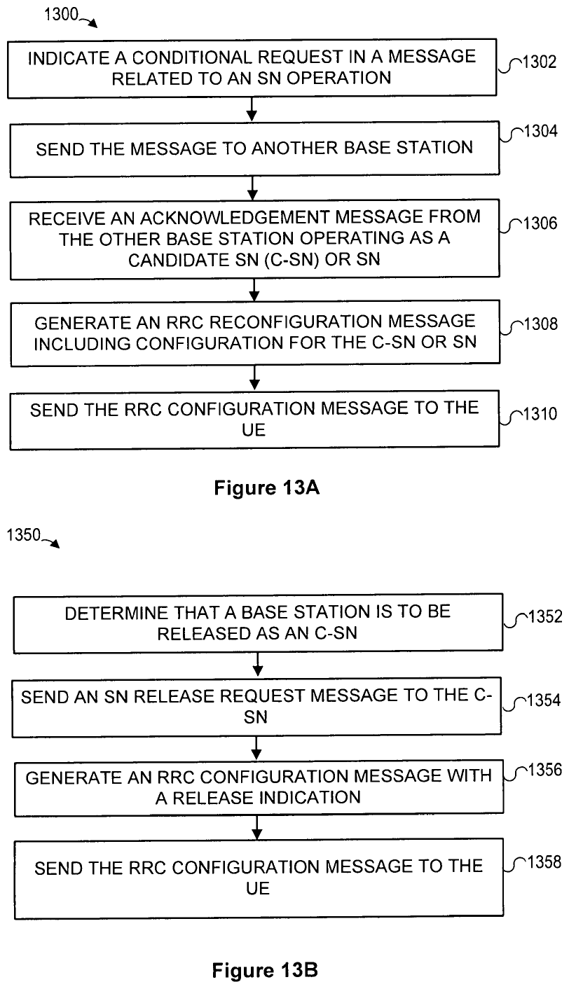

Next, FIG. 13A illustrates an example method 1300 for configuring a UE and a C-SN for addition of the C-SN to a radio connection between the UE and an MN, subject to at least one condition, which can be implemented in the MN 104, for example, or another suitable base station.

The method 1300 starts at block 1302, where the MN indicates a conditional request in a message related to an SN operation. The message can be for example SN Addition Request (event 304), SN Addition or SN Modification Request (event 464). At block 1304, the MN sends a message to another base station, which can be a C-SN (event 304, 704) or the SN (event 464, 864) when the UE already operates in DC. Next, at block 1306, MN receives an acknowledgement from the other base station (event 306, 466, 706). The acknowledgement can include configuration data and one or more conditions. At block 1308, the MN then generates an RRC reconfiguration message including configuration data for the C-SN or the SN and one or more conditions, and sends the RRC reconfiguration message to the UE at block 1310 (308, 468, 708).

FIG. 13B illustrates an example method 1350 for releasing the C-SN and causing the UE to release the configuration data related to the C-SN, which can be implemented in the MN 104, for example, or another suitable base station.

The method 1350 begins at block 1352, where the MN determines a base station is to be released as an C-SN (event 908, 1006). At block 1354, the MN sends an SN release request to the C-SN (event 910, 1008). The MN also generates an RRC message configuration with a release indication at block 1356 and, at block 1358, sends the message to the UE (event 916, 964, 1016, 1064).

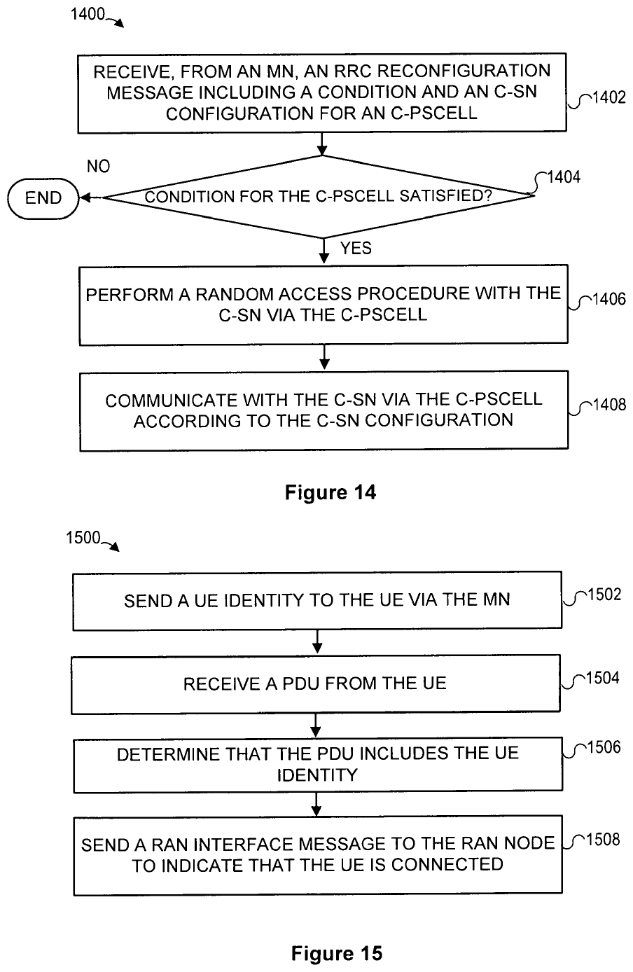

FIG. 14 is a flow diagram of an example method 1440 for connecting to the C-SN via a C-PSCell, after detecting that a condition for connecting to the C-PSCell is satisfied, which can be implemented in the UE 102 or another suitable UE.

The method 1400 begins at block 1402, where the UE receives an RRC reconfiguration message including at least one condition and an C-SN configuration (which may apply to a C-PSCell) (event 308, 468, 708). At block 1404, the UE determines whether the condition is satisfied (event 314, 414, 474, 514, 614, 674, 714) and, if so, proceeds to block 1406 to perform a random access procedure with the C-SN via the C-PSCell (event 316, 416, 476, 516, 616, 676, 716). At block 1408, he UE communicates with the C-SN via the C-PSCell according to the C-SN configuration.

Next, FIG. 15 illustrates an example method 1500 for notifying an MN that a UE has connected to the SN upon completing a conditional SN addition procedure, which can be implemented in a C-SN or SN. The method 150 begins at block 1502, where the SN sends a UE identity to the UE, via the MN, during a conditional SN operation (e.g., SN Addition). Next, at block 1504, the C-SN or the SN receives a PDU from the UE. Upon determining at block 1506 that the PDU includes the UE identity assigned at block 1502, the C-SN or the SN at block 1508 sends a RAN interface message to the RAN node (e.g., the MN or, more precisely, the CU of the MN) to indicate the UE is connected (event 318, 478).

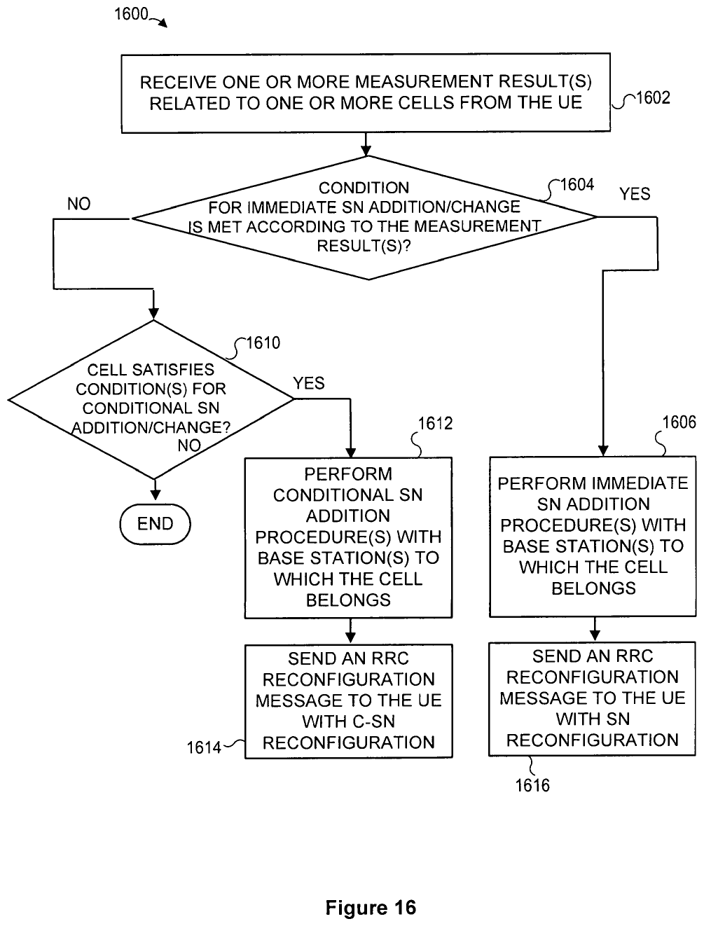

Next, FIG. 16 illustrates an example method 1600 for performing an (immediate) SN Addition or Change (Addition/Change) procedure and an (conditional) SN Addition/Change procedure. The example method 1600 for performing an (immediate) SN Addition or Change (Addition/Change) procedure and an (conditional) SN Addition/Change procedure can be implemented in a suitable base station acting as a MN. For convenience, the method 1600 is discussed below with reference to the base station 104, base station 106A, base station 106B and the UE 102 operating in the wireless communication system 100.

The method 1600 begins at block 1602, where the MN 104 receives one or more measurement results (measurement result(s)) of one or more cells (cell(s)) from the UE 102. At block 1604, the MN 104 determines (i.e., checks or detects) whether a condition for immediate SN Addition/SN Change is met according to measurement result(s) of a cell in the received measurement result(s). If the condition is met, at block 1606, the MN 104 performs an immediate SN Addition/Change procedure with a base station (e.g., base station 106A or 106B) where the cell belongs for the UE 102. At block 1608, the MN 104 transmits the UE 102 an RRC reconfiguration message including a SN configuration configuring a PSCell as a result of the immediate SN Addition/Change procedure. Upon receiving the RRC reconfiguration message, the UE 102 connects to the base station by performing a random access procedure with the base station.

If the condition is not met, at block 1610, the MN 104 determines whether cell(s) meets condition(s) for conditional SN Addition/Change. If the MN 104 determines cells meets condition(s) for the conditional SN Addition/Change, the MN 104 performs one or more conditional SN Addition procedures (SN Addition procedure(s)) with one or more base stations (base station(s)) where the cell(s) belongs at block 1612 to obtain one or more C-SN configurations (C-SN configuration(s)). At block 1614, the MN 104 transmit the UE 102 one or more RRC reconfiguration messages (RRC reconfiguration message(s)) including the C-SN configuration(s) as a result of the conditional SN Addition procedure(s). In some implementations, the MN 104 may include condition(s) for connecting C-PSCell(s) of the C-SN(s) in the one or more RRC reconfiguration messages.

In some implementations, the MN 104 may perform multiple conditional SN Addition procedures with the same C-SN to obtain multiple C-SN configurations for different C-PSCells. In other implementations, the MN 104 may perform multiple conditional SN Addition procedures with different C-SNs to obtain multiple C-SN configurations from the different C-SNs. The MN 104 can transmit one or more RRC reconfiguration messages including the multiple C-SN configurations to the UE 102.

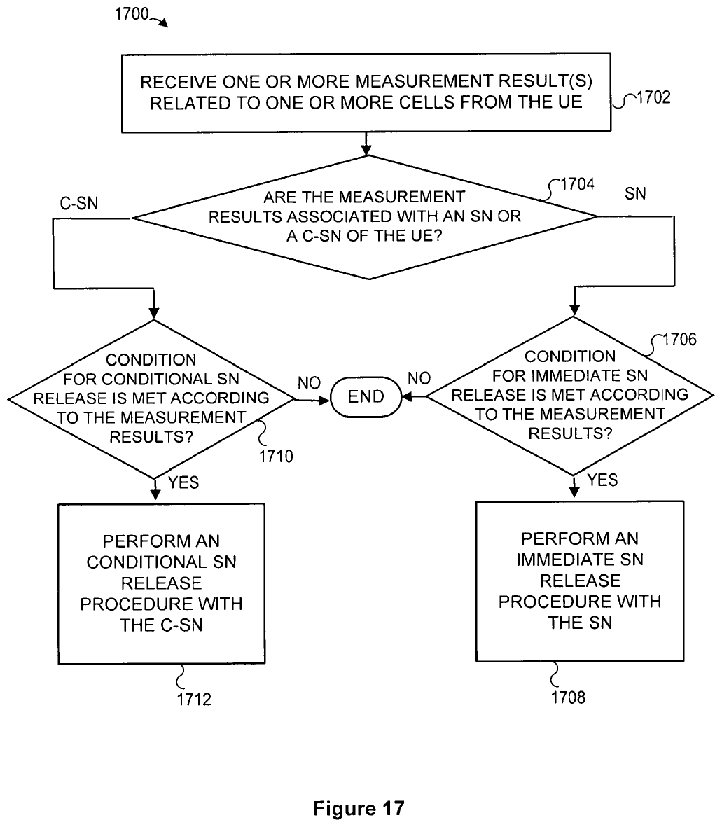

FIG. 17 illustrates an example method 1700 for determining whether a UE should go through an immediate SN release procedure or a conditional SN release procedure, in view of the measurements received from the UE, which can be implemented in the MN 104 or another suitable base station.

The method 1700 begins at block 1702, where the MN receives one or more measurement results related to one or more cells in which the UE operates. The MN determines at block 1704 whether the measurement results are associated with an SN or a C-SN of the UE. When the measurement results are associated with the SN, the flow proceeds to block 1706; otherwise, the flow proceeds to block 1710.

At block 1706, the MN determines whether the condition for immediate SN release is satisfied according to the measurement results and, if so, proceeds to block 1708. The MN performs an immediate SN Release procedure with the SN at block 1708. On the other hand, at block 1710, the MN determines whether the condition for conditional SN release is satisfied according to the measurement results and, if so, proceeds to block 1712. The MN performs a conditional SN Release procedure with the SN at block 1712.

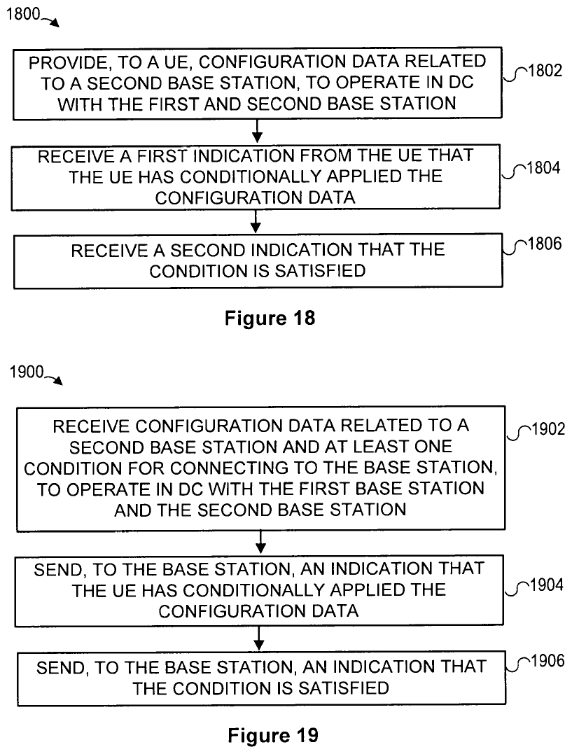

For further clarity, several example methods that can be implemented in the communication devices of FIGS. 1A and 1B are briefly discussed with reference to FIGS. 18-21.

FIG. 18 is a flow diagram of an example method for determining whether a conditional SN addition procedure has been completed, which can be implemented in a base station of FIG. 1A. At block 1802, the base station provides configuration data related to a second base station (e.g., SN or C-SN) (event 304). The base station also can provide one or more conditions for connecting to the second base station. At block 1804, the base station receives an indication from the UE that the UE has conditionally applied the configuration data (event 310, 470). Next, at block 1806, the base station receives a second indication that the condition is satisfied (event 318, 418, 518, 618, 678).

FIG. 19 is a flow diagram of an example method for notifying an MN of connecting to an SN subject to a condition, which can be implemented in the UE of FIG. 1. The method 1900 begins at block 1902, where the UE receives configuration data related to a second base station at least one condition for connecting to the base station, in order to operate in DC with the first base station and the second base station (event 308, 408, 708, 808). At block 904, the UE sends an indication to the base station that he UE has conditionally applied the configuration data (event 310, 470). The UE then sends to the MN another indication that the condition is satisfied (event 518, 618, 678).

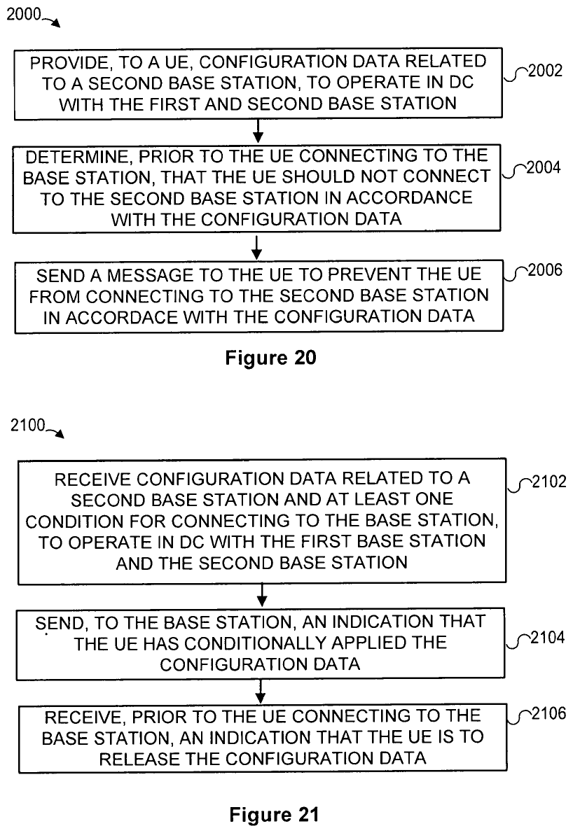

FIG. 20 is a flow diagram of an example method 2000 for modifying a configuration for, or releasing, a C-SN, which can be implemented in a base station of FIG. 1. At block 2002, the base station provides configuration data related to a second base station, to operate in DC with the first and second base stations (events 905, 954, 1004, 1054, 1104, 1154, 1204, 1254). At block 2004, the base station determines, prior to the UE connecting to the UE base station, that the UE should not connect to the second base station in accordance with the previously provided configuration data (event 908, 958, 1006, 1058, 1106, 1158, 1208, 1258). At block 2006, the first base station sends a message to the UE to prevent the UE from connecting to the second base station in accordance with the previously provided configuration data (event 1016, 1064, 916, 964, 1112, 1162, 121, 1262).

FIG. 21 is a flow diagram of an example method 2100 for modifying or releasing configuration data for a C-SN, which can be implemented in the UE of FIG. 1. At block 1902, the UE receives configuration data related to a second base station, to operate in DC with the first and second base stations (events 905, 954, 1004, 1054, 1104, 1154, 1204, 1254). At block 1904, the UE sends an indication to the base station that the UE has conditionally applied the configuration data (events 905, 954, 1004, 1054, 1104, 1154, 1204, 1254). At block 1906, the UE receives, prior to the UE connecting to the second base station, an indication that the UE should release the configuration data (event 908, 958, 1006, 1058, 1106, 1158, 1208, 1258).

The following additional considerations apply to the foregoing discussion.

In some implementations, the MN 104 may initiate an immediate SN Addition procedure with a base station 106B for the UE 102 while the UE 102 is configured with the first C-SN configuration(s). The MN 104 can determine to initiate the immediate SN Addition procedure to configure the base station 106B as a SN to the UE 102, e.g., based on measurement result(s) from the UE 102 or another suitable event. In response to the determination, the MN 104 sends a SN Addition Request message to the SN 106B for the purposes of the immediate SN Addition procedure. In response to the SN Addition Request message, the SN 106B includes a SN configuration in an SN Addition Request Acknowledge message for the UE 102. The SN 106B sends a SN Addition Request Acknowledge message to the MN 104 in response to the SN Addition Request message. The SN configuration include one or more configurations for the UE 102 to communicate with the SN 106B on a primary secondary cell (PSCell) of the SN 106B. The MN 104 transmits a second RRC reconfiguration message including the SN configuration to the UE 102. The UE 102 immediately reacts to the second RRC reconfiguration to transmit a second RRC reconfiguration complete message to the MN 104 and performs a random access procedure on the PSCell with the SN 106B. In one implementation, the UE 102 autonomously releases the first C-SN configuration(s) in response to the second RRC reconfiguration message or the SN configuration. In another implementation, the UE 102 releases the first C-SN configuration(s) if the MN 104 indicates release of the first C-SN configuration(s) in the second RRC reconfiguration message to the UE 102. The MN 104 may configure release of the first C-SN configuration(s) in response to the determination or the immediate SN Addition procedure. Otherwise, the UE 102 may maintain/keep the first C-SN configuration(s). That is, the UE 102 in DC with the MN 104 and the SN 106B still can connect to the C-SN 106A and use the first C-SN configuration(s) to communicate with the C-SN 106A if the UE 102 detects a condition of the condition(s) is satisfied. If the UE 102 connects to the C-SN 106A, the C-SN 106A becomes the SN 106A for the UE 102 and the UE 102 disconnects from the SN 106B.

In some implementations, the MN 104 may initiate an immediate SN Addition procedure or an immediate SN Modification procedure (immediate SN Addition/Modificaiton procedure) with the C-SN 106A for the UE 102 while the UE 102 is configured with the first C-SN configuration(s). The MN 104 can determine to initiate the immediate SN Addition/Modification procedure to configure the base station 106A as a SN to the UE 102, e.g., based on measurement result(s) from the UE 102 or another suitable event. In response to the determination, the MN 104 sends a SN Addition/Modification Request message to the SN 106A for the purposes of the immediate SN Addition/Modification procedure. In response to the SN Addition/Modification Request message, the SN 106B includes a SN configuration in an SN Addition/Modification Request Acknowledge message for the UE 102. The SN 106B sends a SN Addition/Modification Request Acknowledge message to the MN 104 in response to the SN Addition/Modification Request message. The SN configuration include one or more configurations for the UE 102 to communicate with the SN 106B on a primary secondary cell (PSCell) of the SN 106B. The PSCell can be one of the C-PSCell(s) or a cell other than the C-PSCell(s). The MN 104 transmits a second RRC reconfiguration message including the SN configuration to the UE 102. The UE 102 immediately reacts to the second RRC reconfiguration to transmit a second RRC reconfiguration complete message to the MN 104 and performs a random access procedure on the PSCell with the SN 106A. In one implementation, the UE 102 autonomously releases the first C-SN configuration(s) in response to the second RRC reconfiguration message or the SN configuration. In another implementation, the UE 102 releases the first C-SN configuration(s) if the MN 104 indicates release of the first C-SN configuration(s) in the second RRC reconfiguration message to the UE 102. The MN 104 may configure release of the first C-SN configuration(s) in response to the determination or the immediate SN Addition procedure. Otherwise, the UE 102 may maintain/keep the first C-SN configuration(s). That is, the UE 102 in DC with the MN 104 and the SN 106A via the PSCell still can connect to a C-PSCell (e.g., the first C-PSCell) of the SN 106A and use the first C-SN configuration(s) to communicate with the SN 106A via the C-PSCell if the UE 102 detects a condition of the condition(s) is satisfied for the C-PSCell. If the UE 102 connects to the C-SN 106A via the C-PSCell, the C-PSCell becomes a new PSCell for the UE 102 and the UE 102 disconnects from the PSCell (i.e. old PSCell).

In some implementations, the UE 102 autonomously releases the C-SN configuration(s) received from the MN 104 in response to a handover. The UE 102 may receive a handover command from the MN 104 for the handover. In other implementations, the UE 102 does not autonomously release the C-SN configuration(s) received from the MN 104 in response to the handover. The UE 102 having the C-SN configuration(s) releases the C-SN configuration(s) if the handover command configures the UE 102 to do so. The UE 102 having the C-SN configuration(s) keeps (or maintains) the C-SN configuration(s) if the handover command does not configure the UE 102 to release the C-SN configuration(s).

The handover can be an intra-MN handover or an inter-MN handover (i.e., handover from the MN 104 to a base station (e.g., base station 108 not shown in FIG. 1)). In case of the intra-MN handover, the UE 102 transmits a handover complete message to the MN 104 in response to the handover command received from the MN 104. In case of the inter-MN handover, the UE 102 transmits a handover complete message to the base station 108 (i.e., new MN) in response to the handover command received from the MN 104. In some scenarios, the handover command can be a RRCConnectionReconfiguration message including a MobilityControllnfo IE and the handover complete message is a RRCConnectionReconfigurationComplete message. In other scenarios, the handover command can be a RRCReconfiguration message including a ReconfigurationWithSync IE and the handover complete message is a RRCReconfigurationComplete message.

In some implementations, the MN 104 may include a conditional request indication indicating the base station 106A is requested to be a C-SN for the UE 102 in a CG-Configlnfo IE in a SN Addition Request message in a conditional SN Addition/Change procedure. In another implementation, the MN 104 may include the conditional request indication in an IE in the SN Addition Request message. If the base station 106A receive a SN Addition Request message including the indication, the base station 106A determines the SN Addition Request message is for a conditional SN Addition/Change. In response to the SN Addition Request message, the base station 106 A generates a C-SN configuration and includes the C-SN configuration in a SN Addition Request Acknowledge message. If the base station 106A receive a SN Addition Request message excluding the indication, the base station 106A determines the SN Addition Request message is for an immediate SN Addition/Change. In response to the SN Addition Request message, the base station 106 A generates a SN configuration and includes the SN configuration in a SN Addition Request Acknowledge message. In one implementation, the base station 106A may include a C-SN configuration in the SN Addition Request Acknowledge message. In another implementation, the base station 106A may not include a C-SN configuration in the SN Addition Request Acknowledge message.

In some implementations, the MN 104 may include a conditional request indication in a SN Modification Request message in a conditional SN Modification procedure. In another implementation, the MN 104 may include the conditional request indication in an IE in the SN Modification Request message. If the C-SN 106A receive a SN Modification Request message including the indication, the C-SN 106A determines the SN Modification Request message is for a conditional SN Modification and generates an updated C-SN configuration.

In one implementation, the C-SN 106A may start a first timer in response to the conditional SN Addition/Change. When the first timer expires, the C-SN 106A releases the C-SN configuration. If the C-SN 106A connects to a UE receiving the C-SN configuration, e.g., in a random access procedure as described above, the C-SN 106A stops the first timer. If the base station 106 receives a SN Addition Request excluding the indication, the base station 106A determines the SN Addition Request is for an immediate SN Addition/Change and generates a SN configuration. In one implementation, the C-SN 106A may start a second timer in response to the immediate SN Addition/Change. The second timer has a shorter value than the first timer. When the second timer expires, the SN 106A releases the SN configuration. If the SN 106A connects to a UE receiving the SN configuration in a random access procedure, the SN 106A stops the second timer.

In some implementations, the MN 104 may or may not include a SN configuration in a CG-Configlnfo IE in a conditional SN Addition procedure if the UE 102 in DC with the MN 104 and a SN communicates with the SN using the SN configuration. If the SN configuration is included, a C-SN receiving the SN Addition Request message ignores the SN configuration.

In other implementations, the MN 104 may include a SN configuration in a CG-ConfigInfo IE in a conditional SN Addition procedure if the UE 102 in DC with the MN 104 and a SN communicates with the SN using the SN configuration. A C-SN receiving the SN Addition Request message may generate a C-SN configuration according to the SN configuration. If the UE 102 receiving the C-SN configuration determines a condition is met for connecting to the C-SN, the UE 102 updates the SN configuration by the C-SN configuration and communicates with the C-SN using the updated SN configuration.

In some implementations, if a DU of the C-SN 106A identifies the UE 102 in the random access procedure, the DU may send a RAN node interface message to a CU of the C-SN 106A. In some implementations, the RAN node interface message is a F1 AP message defined in 3GPP Technical Specification 38.473. In one implementation, the F1 AP message indicates the UE 102 is connected. In other implementations, the F1 AP message includes the UE identity of the UE 102 so that the CU can identify the UE 102 or determine the UE 102 is connected.

In some implementations, the MN 104 may perform a second conditional SN Addition procedure with a base station 106C (not shown in FIG. 1) to obtain second C-SN configuration(s) for the UE 102, transmit the UE 102 a third RRC reconfiguration message including the second C-SN configuration(s) and condition(s), as similarly described for event 350, 450, 550, 650, 750, 850. The UE 102 may transmit a third RRC reconfiguration complete message to the MN 104 in response to the third RRC reconfiguration message, as similarly described for event 350, 450, 550, 650, 750, 850. In some implementations, the condition(s) in the third RRC reconfiguration message may be same as the condition(s) in the first RRC reconfiguration message. In other implementations, the condition(s) in the third RRC reconfiguration message may be different from the condition(s) in the first RRC reconfiguration message. In some implementations, the first and third RRC reconfiguration messages are the same RRC reconfiguration message. In other implementations, the first and third RRC reconfiguration messages are different RRC reconfiguration messages.

If UE 102 detects one of the condition(s) for connecting to the first C-PSCell is met, or if the UE 102 is performing the random access procedure (event 316, 416, 516, 616, 716, 816) or completes the random access procedure, the UE 102 applies a third C-SN configuration associated to the first C-PSCell in the first C-SN configuration(s) to communicate with the C-SN 106A (becoming the SN 106A) via the first C-PSCell (becoming the first PSCell). In some implementations, the third C-SN configuration includes physical layer configuration(s), MAC configuration(s) and RLC configuration(s). The third C-SN configuration may include radio bearer configuration (RadioBearerConfig). The third C-SN configuration may include Packet Data Convergence Protocol (PDCP) configuration(s) and/or Service Data Adaptation Protocol (SDAP) configuration(s). The third C-SN configuration includes random access configuration(s) for the UE 102 to perform the random access procedure. If the third C-SN configuration does not include a random access configuration, the UE 102 may obtain random access configuration(s) from system information block(s) broadcast on the first C-PSCell.

In some implementations, the UE 102 may release other C-SN configuration(s) associated to other C-PSCell(s) (if configured) in the first C-SN configuration(s) if the UE 102 applies the third C-SN configuration associated to the first C-PSCell as a SN configuration to communicate with the SN 106A or determines the C-SN 106A as a SN or the first C-PSCell as a PSCell. The SN 106A also releases the other C-SN configuration (s) associated to the other C-PSCell(s) (if configured) for the UE 102 if the SN 106A identifies the UE 102 in the random access procedure. Releasing the other C-SN configuration(s) simplifies implementation of the UE 102. In one implementation, the third C-SN configuration is no longer valid for the UE 102 to connect to the base station 106A if the UE 102 later disconnects from the SN 106A. In another implementation, the third C-SN configuration is still valid for the UE 102 to connect back to the base station 106A if the UE 102 later disconnects from the SN 106A.

In other implementations, the UE 102 may maintain the other C-SN configuration(s) (if configured) associated to the other C-PSCell(s) if the UE applies the third C-SN configuration associated to the first C-PSCell to communicate with the SN 106A. The SN 106A also keeps the other C-SN configuration (s) associated to the other C-PSCell(s) (if configured) for the UE 102 if the SN 106A identifies the UE 102 in the random access procedure. Keeping the other C-SN configuration(s) increases complexity in implementation of the UE 102. However, it provides benefits that the UE 102 can quickly change from the first C-PSCell to a second C-PSCell associated to one of the other C-SN configuration(s) if the UE 102 detects a condition of the condition(s) is met for connecting to the second C-PSCell. In these cases, the UE 102 just performs a second random access procedure on the second C-PSCell with the SN 106A to connect to the SN 106A via the second C-PSCell.

In some implementations, the UE 102 may release the second C-SN configuration(s) (if configured) if the UE 102 applies the third C-SN configuration associated to the first C-PSCell to communicate with the SN 106A. The MN 104 sends a SN Release Request message to the SN 106C in response to the RAN node interface message. The SN 106C also releases the second C-SN configuration (s) (if configured) for the UE 102 in response to the SN Release Request message. Releasing the other C-SN configuration(s) simplifies implementation of the UE 102. In other implementations, the UE 102 may maintain the second C-SN configuration(s) (if configured) if the UE applies the third C-SN configuration associated to the first C-PSCell. In these cases, the MN 104 does not send the SN Release Request message to the SN 106C so that the SN 106C also keeps the second C-SN configuration(s) (if configured) for the UE 102. Keeping the second C-SN configuration(s) increases complexity in implementation of the UE 102. However, it provides benefits that the UE 102 can quickly change from the SN 106A to the C-SN 106C if the UE 102 detects a condition of the condition(s) is met for a second C-PSCell associated to one of the second C-SN configuration(s). In these cases, the UE 102 just performs a second random access procedure on the second C-PSCell with the SN 106C to connect to the C-SN 106C.

In some implementations, the UE 102 may autonomously release the second C-SN configuration(s) (if configured) if the UE 102 receives the SN configuration from the MN 104 as described above. The MN 104 may send a SN Release Request message to the SN 106C in response to the immediate SN Addition procedure causing the SN configuration is generated. The SN 106C also releases the second C-SN configuration (s) (if configured) for the UE 102 in response to the SN Release Request message. Releasing the other C-SN configuration(s) simplifies implementation of the UE 102. In other implementations, the UE 102 releases the second C-SN configuration(s) (if configured) if the MN 104 indicates release of the first C-SN configuration(s) in the second RRC reconfiguration message configuring the SN configuration to the UE 102. The MN 104 may send a SN Release Request message to the SN 106C. The SN 106C also releases the second C-SN configuration (s) (if configured) for the UE 102 in response to the SN Release Request message. If the MN 104 indicates keeping (or does not indicate release) of the first C-SN configuration(s) in the second RRC reconfiguration message configuring the SN configuration to the UE 102, the UE 102 maintains the second C-SN configuration(s). Keeping the second C-SN configuration(s) increases complexity in implementation of the UE 102. However, it provides benefits that the UE 102 can quickly change from the SN (e.g., SN 106A or SN 106B) to the C-SN 106C if the UE 102 detects a condition of the condition(s) is met for a C-PSCell of the C-SN 106C associated to one of the second C-SN configuration(s). In these cases, the UE 102 just performs a second random access procedure on the C-PSCell with the SN 106C to connect to the C-SN 106C.

If the MN 104 is a MeNB or Mng-eNB, the RRC reconfiguration messages above can be RRCConnectionReconfiguration messages and the RRC reconfiguration complete messages above can be RRCConnectionReconfigurationComplete messages. If the MN 104 is a MgNB, the RRC reconfiguration messages can be RRCReconfiguration messages and the RRC reconfiguration complete messages above can be RRCReconfigurationComplete messages. In some implementations, the RRC reconfiguration message described above used to include the C-SN configurations can be an RRC messages other than the RRC reconfiguration message. For example, the RRC message can be a newly defined RRC message. The UE 102 may or may not transmit an RRC response message in response to the newly defined RRC message. The RRC response message can be a RRC reconfiguration complete message or a newly defined RRC response message.

If the MN 104 is a MeNB or Mng-eNB, the Assistance Information message can be a EUTRA UEAssistancelnformation message. If the MN 104 is a MgNB, the Assistance Information message can be a NR UEAssistancelnformation message.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

The following list of aspects reflects another additional embodiment explicitly contemplated by the present disclosure.

1. A method in a first base station communicating data with a user equipment (UE), the method comprising: providing to the UE, by processing hardware, configuration data related to a second base station and at least one condition for connecting to the second base station in order to operate in dual connectivity with the first base station and the second base station; receiving from the UE, by the processing hardware, a first indication that the UE has conditionally applied the configuration data; and subsequently to receiving the first indication, receiving a second indication that the at least one condition is satisfied.

2. The method of aspect 1, further comprising: subsequently to receiving the second indication, sending a sequence number (SN) status transfer message to the second base station.

3. The method of aspect 2, further comprising: operating in dual connectivity (DC) with the UE and a third base station prior to providing the configuration; and subsequently to receiving the second indication, sending, to the third base station, an indication that the third base station is to be released from the DC.

4. The method of aspect 1, further comprising: prior to providing the configuration, operating in (i) single connectivity (SC) with the UE or (ii) DC with the UE and a third base station.

5. The method of aspect 1, further comprising: prior to providing the configuration, operating in DC with the UE and a first cell of the second base station, wherein the at least one condition is for connecting to a second cell of the second base station.

6. The method of aspect 5, wherein the second cell is a primary secondary cell (PSCell).

7. The method of aspect 5, further comprising sending, to the second base station, one of: a request to add the second base station as a secondary node, or a request to modify the second base station operating as a secondary node.

8. The method of any of the preceding aspects, wherein receiving the first indication includes receiving a radio access network (RAN) node interface message from the second base station.

9. The method of any of aspects 1-7, wherein receiving the first indication includes receiving a message from the UE.

10. The method of aspect 9, wherein the message is an assistance information message.

11. The method of aspect 1, wherein receiving the first indication includes receiving a message associated with a protocol for controlling radio resources, the message indicating that reconfiguration of a radio connection is complete.

12. A base station comprising processing hardware and configured to implement a method of any of aspects 1-11.

13. A method in a UE communicating data with a first base station, the method comprising: receiving from the first base station, by processing hardware, configuration data related to a second base station and at least one condition for connecting to the second base station to operate in DC with the first base station and the second base station; transmitting to the base station, by the processing hardware, a first indication that the UE has conditionally applied the configuration data; and subsequently to determining that the at least one condition is satisfied, sending a second indication to the first base station, to indicate that the at least one condition is satisfied.

14. The method of aspect 13, further comprising, subsequently to determining that the at least one condition is satisfied but prior to sending the second indication: performing a random access procedure with the second base station.

15. The method of aspect 14, further comprising: prior to receiving the configuration data, operating in DC with the first base station and a first cell of the second base station; wherein performing the random access procedure with the second base station includes performing the random access procedure with a second cell of the second base station.

16. The method of aspect 15, wherein the second cell is a primary secondary cell (PSCell).

17. The method of aspect 13, wherein the sending the second indication includes sending an assistance information message.

18. A UE comprising processing hardware and configured to implement a method of any of aspects 13-17.

19. A method in a first base station communicating data with a user equipment (UE), the method comprising: providing to the UE, by processing hardware, configuration data related to a second base station and at least one condition for connecting to the second base station in order to operate in dual connectivity (DC) with the first base station and the second base station; determining, by the processing hardware prior to the UE connecting to the second base station, that the UE should not connect to the second base station in accordance with the first configuration data; and sending, by the processing hardware to the UE, a message to prevent the UE from the connecting to the second base station in accordance with the configuration data.

20. The method of aspect 19, wherein sending the message includes sending an indication that the UE is to release the configuration data.

21. The method of aspect 20, wherein the message is a Radio Resource Control (RRC) Reconfiguration command.

22. The method of aspect 19, further comprising: in response to determining that the UE should not connect to the second base station, sending, to the second base station, an indication that the second base station is to be released from the DC.

23. The method of aspect 19, wherein: determining that the UE should not connect to the second base station includes receiving, from the second base station, an indication that a release of the second base from the DC is required.

24. The method of aspect 19, further comprising: in response to determining that the UE should not connect to the second base station, sending, to the second base station, a request to release a context of the UE.

25. The method of aspect 19, wherein: the configuration data is first configuration data; and sending the message to the UE includes providing a second configuration data to the UE.

26. The method of aspect 25, further comprising: sending, by the processing hardware, the second configuration data to the second base station.

27. The method of aspect 26, wherein sending the second configuration data includes sending an SN Modification Request message.

28. The method of any of aspects 19-27, further comprising: operating in single connectivity (SC) with the UE prior to providing the configuration data to the UE.

29. The method of any of aspects 19-27, further comprising: operating in dual connectivity (DC) with the UE and a third base station prior to providing the configuration data to the UE.

30. A base station comprising processing hardware and configured to implement a method of any of aspects 19-29.

31. A method in a UE communicating data with a first base station, the method comprising: receiving from the base station, by processing hardware, configuration data related to a second base station and at least one condition for connecting to the second base station to operate in DC with the first base station and the second base station; transmitting to the base station, by the processing hardware, a first indication that the UE has conditionally applied the configuration data; and prior to determining that the at least one condition is satisfied, receiving, from the base station, an indication that the configuration data is to be released.

32. The method of aspect 31, wherein: the configuration data is a first configuration data; and receiving the indication that the first configuration data is to be released includes receiving second configuration data.

33. The method of aspect 31, the message is a Radio Resource Control (RRC) Reconfiguration command.

34. The method of aspect 31, further comprising: prior to receiving the configuration data, operating in SC with the first base station.

35. The method of aspect 31, further comprising: prior to receiving the configuration data, operating in DC with the first base station and a third base station.

36. A UE comprising processing hardware and configured to implement a method of any of aspects 13-17.

What is claimed is:

1. A method in a first base station communicating data with a user equipment (UE), the method comprising
providing to the UE, by processing hardware, configuration data related to a second base station and at least one condition for connecting to the second base station in order to operate in dual connectivity with the first base station and the second base station;
receiving from the UE, by the processing hardware, a first indication that the UE has conditionally applied the configuration data; and
subsequently to receiving the first indication, receiving a second indication that the at least one condition is satisfied.

2. The method of claim 1, further comprising:
subsequently to receiving the second indication, sending a sequence number (SN) status transfer message to the second base station.

3. The method of claim 2, further comprising:
operating in dual connectivity (DC) with the UE and a third base station prior to providing the configuration; and
subsequently to receiving the second indication, sending, to the third base station, an indication that the third base station is to be released from the DC.

4. The method of claim 1, further comprising:
prior to providing the configuration, operating in DC with the UE and a first cell of the second base station, wherein the at least one condition is for connecting to a second cell of the second base station.

5. The method of claim 4, wherein the second cell is a primary secondary cell (PSCell).

6. The method of claim 4, further comprising sending, to the second base station, one of:
a request to add the second base station as a secondary node, or
a request to modify the second base station operating as a secondary node.

7. The method of any of the preceding claims, wherein receiving the first indication includes receiving a radio access network (RAN) node interface message from the second base station.

8. The method of any of claims 1-6, wherein receiving the first indication includes receiving an assistance information message from the UE.

9. The method of claim 1, wherein receiving the first indication includes receiving a message associated with a protocol for controlling radio resources, the message indicating that reconfiguration of a radio connection is complete.

10. A base station comprising processing hardware and configured to implement a method of any of claims 1-9.

11. A method in a UE communicating data with a first base station, the method comprising:
receiving from the first base station, by processing hardware, configuration data related to a second base station and at least one condition for connecting to the second base station to operate in DC with the first base station and the second base station;
transmitting to the base station, by the processing hardware, a first indication that the UE has conditionally applied the configuration data; and
subsequently to determining that the at least one condition is satisfied, sending a second indication to the first base station, to indicate that the at least one condition is satisfied.

12. The method of claim 11, further comprising, subsequently to determining that the at least one condition is satisfied but prior to sending the second indication:
performing a random access procedure with the second base station.

13. The method of claim 12, further comprising:
prior to receiving the configuration data, operating in DC with the first base station and a first cell of the second base station;
wherein performing the random access procedure with the second base station includes performing the random access procedure with a second cell of the second base station.

14. The method of claim 13, wherein the second cell is a primary secondary cell (PSCell).

15. A UE comprising processing hardware and configured to implement a method of any of claims 11-14.
